(19) United States
(12) Patent Application Publication
(10) Pub. No.: US 2020/0028623 A1
(43) Pub. Date: Jan. 23, 2020

(54) BLOCK BASED PREAMBLE DESIGN FOR AUTONOMOUS UPLINK TRANSMISSIONS

(71) Applicant: QUALCOMM Incorporated, San Diego, CA (US)

(72) Inventors: Seyong Park, San Diego, CA (US); Jing Lei, San Diego, CA (US); Jay Kumar Sundararajan, San Diego, CA (US); Joseph Binamira Soriaga, San Diego, CA (US); Gabi Sarkis, San Diego, CA (US); Naga Bhushan, San Diego, CA (US); Tingfang Ji, San Diego, CA (US); Peter Gaal, San Diego, CA (US); Ying Wang, San Diego, CA (US)

(21) Appl. No.: 16/517,652

(22) Filed: Jul. 21, 2019

Related U.S. Application Data
(60) Provisional application No. 62/702,325, filed on Jul. 23, 2018.

(51) Int. Cl. H04L 1/00; H04L 5/00; H04L 5/10; H04W 24/08; H04W 72/04; H04W 76/27; H04J 13/00; H04W 74/08

(52) U.S. Cl. CPC H04L 1/0071; H04L 5/0082; H04L 5/10; H04L 5/0051; H04W 24/08; H04W 74/0833; H04W 76/27; H04W 72/0466; H04J 13/0062; H04J 13/0029; H04W 72/042

(57) ABSTRACT

Methods, systems, and devices for wireless communications are described. A base station may assign a set of preamble blocks for autonomous uplink transmissions from a preamble block pool. A user equipment (UE) may identify indices for each of a set of indexed sequences to be transmitted over the set of preamble blocks. The UE may select or identify the indices by performing an encoding procedure on a set of parameters. The indices may be applied to the pool of indexed sequences, and the resulting set of sequences may be transmitted over the set of assigned preamble blocks. The base station may recognize composite sequences transmitted from UEs on respective sets of preamble blocks based on the set of sequences. Thus, the base station may identify a data transmission from the UE based on monitoring for and identifying the set of sequences transmitted on the preamble blocks.

### CROSS REFERENCE

The present Application for Patent claims the benefit of U.S. Provisional Patent Application No. 62/702,325 by PARK, et al., entitled “BLOCK BASED PREAMBLE DESIGN FOR AUTONOMOUS UPLINK TRANSMISSIONS,” filed Jul. 23, 2018, assigned to the assignee hereof, and expressly incorporated herein.

### BACKGROUND

The following relates generally to wireless communications, and more specifically to block based preamble design for autonomous uplink transmissions.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

In some wireless communications systems, such as those operating in New Radio (NR), non-orthogonal multiple access (NOMA) techniques may be used to serve multiple users over the same time-frequency resources using multiple access (MA) sequences to assist in distinguishing between transmissions from different UEs. For example, NOMA techniques may be applied to autonomous uplink transmissions (e.g., transmissions not associated with a grant of resources by a base station to a UE). In some cases, a base station may be capable of receiving autonomous uplink transmissions from a large number of UEs. In such examples, the base station may detect a preamble from a UE and may determine that the UE is transmitting on resources designated for autonomous uplink transmissions based on the preamble. However, in cases where multiple UEs are transmitting preambles on the same set of resources, it may be difficult or impossible for the base station to determine which UE is transmitting. Thus, efficient preamble design for autonomous uplink transmissions may serve to optimize network performance.

### SUMMARY

The described techniques relate to improved methods, systems, devices, and apparatuses that support block based preamble design for autonomous uplink transmissions. A base station may assign a set of preamble blocks for autonomous uplink transmissions from a preamble block pool. A user equipment (UE) may identify indices for each of a set of indexed sequences to be transmitted over the set of preamble blocks. The indices may be based on a set of parameters.

The parameters may be associated with the UE or the cell (e.g., UE identifier, cell identifier, and the like) or may be signaled from the base station (e.g., received via radio resource control (RRC) signaling, downlink control information (DCI) signaling, or some combination thereof). The UE may identify the indices by performing an encoding procedure on the parameters to increase hamming distance between indices or decrease cross correlation between selected sequences for transmission on preamble blocks. The encoding procedure may include various methods for encoding, interleaving, scrambling, or the like. The encoding procedure may produce, from the parameters, the set of indices. The encoding procedure may amplify differences between a bit stream representing parameters for a first UE, and a bit stream representing parameters for a second UE.

The indices may be applied to the pool of indexed sequences, and the resulting set of sequences may be transmitted over the set of preamble blocks assigned from the preamble block pool. The base station may also apply the encoding procedure to the known set of parameters to obtain the indices, and apply the indices to the pool of indexed sequences. The base station may recognize composite sequences transmitted from one or more UEs on respective sets of preamble blocks based on the set of sequences. Thus, the base station may monitor the preamble block pool for composite sequences and may identify a transmission of the preamble from a UE and an associated data transmission from the UE based on monitoring for and identifying the set of sequences transmitted on the preamble blocks.

A method of wireless communication at a UE is described. The method may include identifying a set of preamble blocks for autonomous uplink transmissions, the set of preamble blocks being assigned by a base station from a pool of preamble blocks, identifying an index for each preamble block of the set of preamble blocks, each of the selected indices corresponding to one of a set of indexed sequences, transmitting one or more of the indexed sequences over the set of preamble blocks, the one or more of the indexed sequences corresponding to the identified indices for the set of preamble blocks, and transmitting a data transmission during a transmission time interval (TTI) associated with the set of preamble blocks.

An apparatus for wireless communication at a UE is described. The apparatus may include a processor, memory coupled (e.g., in electronic communication) with the processor, and instructions stored in the memory. The instructions may be executable by the processor to cause the apparatus to identify a set of preamble blocks for autonomous uplink transmissions, the set of preamble blocks being assigned by a base station from a pool of preamble blocks, identify an index for each preamble block of the set of preamble blocks, each of the identified indices corresponding to one of a set of indexed sequences, transmit one or more of the indexed sequences over the set of preamble blocks, the one or more of the indexed sequences corresponding to the identified indices for the set of preamble blocks, and transmit a data transmission during a TTI associated with the set of preamble blocks.

Another apparatus for wireless communication at a UE is described. The apparatus may include means for identifying a set of preamble blocks for autonomous uplink transmissions, the set of preamble blocks being assigned by a base station from a pool of preamble blocks, identifying an index for each preamble block of the set of preamble blocks, each of the identified indices corresponding to one of a set of indexed sequences, transmitting one or more of the indexed sequences over the set of preamble blocks, the one or more of the indexed sequences corresponding to the identified indices for the set of preamble blocks, and transmitting a data transmission during a TTI associated with the set of preamble blocks.

A non-transitory computer-readable medium storing code for wireless communication at a UE is described. The code may include instructions executable by a processor to identify a set of preamble blocks for autonomous uplink transmissions, the set of preamble blocks being assigned by a base station from a pool of preamble blocks, identify an index for each preamble block of the set of preamble blocks, each of the identified indices corresponding to one of a set of indexed sequences, transmit one or more of the indexed sequences over the set of preamble blocks, the one or more of the indexed sequences corresponding to the identified indices for the set of preamble blocks, and transmit a data transmission during a TTI associated with the set of preamble blocks.

In some examples of the method, apparatuses, and non-transitory computer-readable medium described herein, identifying the index for each preamble block of the set of preamble blocks further may include operations, features, means, or instructions for identifying a set of parameters, the set of parameters including a cell identifier, a UE identifier, a timing index, a parameter received via DCI signaling or RRC signaling, or a combination thereof.

In some examples of the method, apparatuses, and non-transitory computer-readable medium described herein, identifying the index for each preamble block of the set of preamble blocks may include operations, features, means, or instructions for performing an encoding procedure on the set of parameters to obtain a series of indices and mapping each of the series of indices to the corresponding one of the set of indexed sequences to obtain the one or more of the indexed sequences.

In some examples of the method, apparatuses, and non-transitory computer-readable medium described herein, performing the encoding procedure may include operations, features, means, or instructions for representing the set of parameters as a bit stream, dividing the bit stream into a set of substreams, performing a stream encoding operation on the set of substreams to obtain a set of encoded substreams, a number of encoded substreams in the set of encoded substreams corresponding to a number of preamble blocks in the set of preamble blocks and mapping each encoded substream of the set of encoded substreams to a respective one of the set of indexed sequences.

In some examples of the method, apparatuses, and non-transitory computer-readable medium described herein, performing the stream encoding operation may include operations, features, means, or instructions for mapping each of the set of substreams to one of a first set of numbers, the first set of numbers having a first dimension.

In some examples of the method, apparatuses, and non-transitory computer-readable medium described herein, the performing the stream encoding operation may include operations, features, means, or instructions for encoding the mapped set of sub streams according to a generator matrix to obtain the set of encoded sub streams, where a dimension of the generator matrix corresponds to the number of preamble blocks.

In some examples of the method, apparatuses, and non-transitory computer-readable medium described herein, performing the encoding procedure may include operations, features, means, or instructions for representing the set of parameters as bit stream, encoding the bit stream to obtain an encoded bit stream, dividing the encoded bit stream into a set of encoded sub streams, a number of encoded sub streams in the set of encoded substreams corresponding to a number of preamble blocks in the set of preamble blocks and mapping each encoded sub stream of the set of encoded sub streams to a respective one of the set of indexed sequences.

In some examples of the method, apparatuses, and non-transitory computer-readable medium described herein, performing the encoding procedure may include operations, features, means, or instructions for interleaving and scrambling the bit stream prior to the encoding.

In some examples of the method, apparatuses, and non-transitory computer-readable medium described herein, performing the encoding procedure may include operations, features, means, or instructions for interleaving and scrambling the encoded bit stream prior to the dividing.

In some examples of the method, apparatuses, and non-transitory computer-readable medium described herein, each preamble block of the set of preamble blocks includes a set of time-frequency resources.

In some examples of the method, apparatuses, and non-transitory computer-readable medium described herein, identifying the set of preamble blocks further may include operations, features, means, or instructions for mapping the set of preamble blocks to a set of physical resources according to a mapping function.

In some examples of the method, apparatuses, and non-transitory computer-readable medium described herein, the mapping function may include operations, features, means, or instructions for mapping the preamble blocks to consecutive time-frequency resources, interleaved time-frequency resources, or comb based interleaved time-frequency resources.

In some examples of the method, apparatuses, and non-transitory computer-readable medium described herein, each indexed sequence of the set of indexed sequences may be a Zadoff-Chu sequence with a respective root and cyclic shift, a gold sequence with a respective initial register status, a Galois sequence, an orthogonal basis sequence, or any combination thereof.

Some examples of the method, apparatuses, and non-transitory computer-readable medium described herein may further include operations, features, means, or instructions for transmitting a demodulation reference signal (DMRS) after transmitting the one or more of the indexed sequences over the set of preamble blocks and prior to transmitting the data transmission.

Some examples of the method, apparatuses, and non-transitory computer-readable medium described herein may further include operations, features, means, or instructions for identifying a set of parameters, the set of parameters including a cell identifier, a UE identifier, a parameter received via a DCI, a parameter received via an RRC signal, or a combination thereof and transmitting the DMRS based on the set of parameters.

In some examples of the method, apparatuses, and non-transitory computer-readable medium described herein, the resources of each preamble block of the set of preamble blocks may be bounded by a set of rules.

In some examples of the method, apparatuses, and non-transitory computer-readable medium described herein, identifying the set of preamble blocks further may include operations, features, means, or instructions for receiving signaling from the base station assigning the set of preamble blocks for autonomous uplink transmissions via RRC signaling, DCI signaling, system information (SI) signaling, or a combination thereof.

In some examples of the method, apparatuses, and non-transitory computer-readable medium described herein, identifying the set of indexed sequences further may include operations, features, means, or instructions for receiving signaling, from the base station, configuring the set of indexed sequences via RRC signaling, DCI signaling, SI signaling, or a combination thereof.

A method of wireless communication at a base station is described. The method may include assigning respective sets of preamble blocks to a set of user equipments (UEs) for autonomous uplink transmissions, each of the respective sets of preamble blocks assigned from a pool of preamble blocks, identifying a set of indexed sequences for transmission over the respective sets of preamble blocks, monitoring the pool of preamble blocks for composite sequences transmitted from the set of UEs over the respective sets of preamble blocks, each of the composite sequences including one or more indexed sequences of the set of indexed sequences, identifying one or more transmissions from one or more of the set of UEs based on detecting one or more corresponding composite sequences from the monitoring, and receiving the one or more transmissions.

An apparatus for wireless communication at a base station is described. The apparatus may include a processor, memory coupled with (e.g., in electronic communication with) the processor, and instructions stored in the memory. The instructions may be executable by the processor to cause the apparatus to assign respective sets of preamble blocks to a set of UEs for autonomous uplink transmissions, each of the respective sets of preamble blocks assigned from a pool of preamble blocks, identify a set of indexed sequences for transmission over the respective sets of preamble blocks, monitor the pool of preamble blocks for composite sequences transmitted from the set of UEs over the respective sets of preamble blocks, each of the composite sequences including one or more indexed sequences of the set of indexed sequences, identify one or more transmissions from one or more of the set of UEs based on detecting one or more corresponding composite sequences from the monitoring, and receive the one or more transmissions.

Another apparatus for wireless communication at a base station is described. The apparatus may include means for assigning respective sets of preamble blocks to a set of UEs for autonomous uplink transmissions, each of the respective sets of preamble blocks assigned from a pool of preamble blocks, identifying a set of indexed sequences for transmission over the respective sets of preamble blocks, monitoring the pool of preamble blocks for composite sequences transmitted from the set of UEs over the respective sets of preamble blocks, each of the composite sequences including one or more indexed sequences of the set of indexed sequences, identifying one or more transmissions from one or more of the set of UEs based on detecting one or more corresponding composite sequences from the monitoring, and receiving the one or more transmissions.

A non-transitory computer-readable medium storing code for wireless communication at a base station is described. The code may include instructions executable by a processor to assign respective sets of preamble blocks to a set of UEs for autonomous uplink transmissions, each of the respective sets of preamble blocks assigned from a pool of preamble blocks, identify a set of indexed sequences for transmission over the respective sets of preamble blocks, monitor the pool of preamble blocks for composite sequences transmitted from the set of UEs over the respective sets of preamble blocks, each of the composite sequences including one or more indexed sequences of the set of indexed sequences, identify one or more transmissions from one or more of the set of UEs based on detecting one or more corresponding composite sequences from the monitoring, and receive the one or more transmissions.

Some examples of the method, apparatuses, and non-transitory computer-readable medium described herein may further include operations, features, means, or instructions for identifying a set of parameters associated with a UE of the set of UEs, the set of parameters including a cell identifier, a UE identifier, a timing index, a parameter transmitted to the each of the set of UEs via DCI signaling or RRC signaling, or a combination thereof.

In some examples of the method, apparatuses, and non-transitory computer-readable medium described herein, monitoring the pool of preamble blocks for the composite sequences further may include operations, features, means, or instructions for performing an encoding procedure on the set of parameters to obtain a series of indices, mapping each of the series of indices to the corresponding one of the set of indexed sequences to obtain the one or more indexed sequences and monitoring the pool of preamble blocks for the composite sequences based on the mapping.

In some examples of the method, apparatuses, and non-transitory computer-readable medium described herein, performing the encoding procedure may include operations, features, means, or instructions for representing the set of parameters as a bit stream, dividing the bit stream into a set of sub streams, performing a stream encoding operation on the set of substreams to obtain a set of encoded substreams, a number of encoded substreams in the set of encoded substreams corresponding to a number of preamble blocks in the respective set of preamble blocks, mapping each encoded substream of the set of encoded sub streams to a respective one of the set of indexed sequences and monitoring the pool of preamble blocks for the composite sequences based on the mapped set of encoded sub streams.

In some examples of the method, apparatuses, and non-transitory computer-readable medium described herein, performing the stream encoding operation may include operations, features, means, or instructions for mapping each of the set of substreams to one of a first set of numbers, the first set of numbers having a first dimension.

In some examples of the method, apparatuses, and non-transitory computer-readable medium described herein, performing the stream encoding operation may include operations, features, means, or instructions for encoding the mapped set of substreams according to a generator matrix to obtain the set of encoded sub streams, where a dimension of the generator matrix corresponds to the number of preamble blocks.

In some examples of the method, apparatuses, and non-transitory computer-readable medium described herein, performing the encoding procedure may include operations, features, means, or instructions for representing the set of parameters as bit stream, encoding the bit stream to obtain an encoded bit stream, dividing the encoded bit stream into a set of encoded sub streams, a number of encoded sub streams in the set of encoded substreams corresponding to a number of preamble blocks in the respective set of preamble blocks and mapping each encoded substream of the set of encoded substreams to a respective one of the set of indexed sequences.

In some examples of the method, apparatuses, and non-transitory computer-readable medium described herein, performing the encoding procedure may include operations, features, means, or instructions for interleaving and scrambling the bit stream prior to the encoding.

In some examples of the method, apparatuses, and non-transitory computer-readable medium described herein, performing the encoding procedure may include operations, features, means, or instructions for interleaving and scrambling the encoded bit stream prior to the dividing.

In some examples of the method, apparatuses, and non-transitory computer-readable medium described herein, each preamble block of the respective sets of preamble blocks includes a set of time-frequency resources.

In some examples of the method, apparatuses, and non-transitory computer-readable medium described herein, assigning the respective sets of preamble blocks further may include operations, features, means, or instructions for mapping the preamble blocks to consecutive time-frequency resources, interleaved time-frequency resources, or comb based interleaved time-frequency resources.

In some examples of the method, apparatuses, and non-transitory computer-readable medium described herein, each indexed sequences of the set of indexed sequences may be a Zadoff-Chu sequence with a respective root and cyclic shift, a gold sequence with a respective initial register status, a Galois sequence, an orthogonal basis sequence, or any combination thereof.

In some examples of the method, apparatuses, and non-transitory computer-readable medium described herein, receiving the one or more transmissions may include operations, features, means, or instructions for receiving a composite sequence of the one or more corresponding composite sequences from a UE of the set of UEs, receiving a demodulation reference signal (DMRS) after receiving the composite sequence and receiving a data transmission after receiving the DMRS.

Some examples of the method, apparatuses, and non-transitory computer-readable medium described herein may further include operations, features, means, or instructions for identifying a set of parameters, the set of parameters including a cell identifier, a UE identifier, a parameter transmitted to the each of the set of UEs via DCI signaling or resource control (RRC) signaling, or a combination thereof and receiving the DMRS based on the set of parameters.

In some examples of the method, apparatuses, and non-transitory computer-readable medium described herein, each preamble block of the respective sets of preamble blocks may be bounded by a set of rules.

Some examples of the method, apparatuses, and non-transitory computer-readable medium described herein may further include operations, features, means, or instructions for transmitting signaling, to the set of UEs, the signaling configuring the set of indexed sequences via RRC signaling, DCI signaling, system information (SI) signaling, or a combination thereof.

### BRIEF DESCRIPTION OF THE DRAWINGS

FIG. 1 illustrates an example of a system for wireless communications that supports block based preamble design for autonomous uplink transmissions in accordance with aspects of the present disclosure.

FIG. 2 illustrates an example of a wireless communications system that supports block based preamble design for autonomous uplink transmissions in accordance with aspects of the present disclosure.

FIG. 3 illustrates an example of a preamble block assignment scheme that supports block based preamble design for autonomous uplink transmissions in accordance with aspects of the present disclosure.

FIG. 4 illustrates an example of a dynamic autonomous uplink transmission schedule that supports block based preamble design for autonomous uplink transmissions in accordance with aspects of the present disclosure.

FIG. 5 illustrates an example of an encoding procedure that supports block based preamble design for autonomous uplink transmissions in accordance with aspects of the present disclosure.

FIG. 6 illustrates an example of an encoding procedure that supports block based preamble design for autonomous uplink transmissions in accordance with aspects of the present disclosure.

FIG. 7 illustrates an example of a subframe structure that supports block based preamble design for autonomous uplink transmissions in accordance with aspects of the present disclosure.

FIG. 8 illustrates an example of a subframe structure that supports block based preamble design for autonomous uplink transmissions in accordance with aspects of the present disclosure.

FIG. 9 illustrates an example of a subframe structure that supports block based preamble design for autonomous uplink transmissions in accordance with aspects of the present disclosure.

FIG. 10 illustrates an example of a subframe structure that supports block based preamble design for autonomous uplink transmissions in accordance with aspects of the present disclosure.

FIG. 11 illustrates an example of a process flow that supports block based preamble design for autonomous uplink transmissions in accordance with aspects of the present disclosure.

FIGS. 12 and 13 show block diagrams of devices that support block based preamble design for autonomous uplink transmissions in accordance with aspects of the present disclosure.

FIG. 14 shows a block diagram of a communications manager that supports block based preamble design for autonomous uplink transmissions in accordance with aspects of the present disclosure.

FIG. 15 shows a diagram of a system including a device that supports block based preamble design for autonomous uplink transmissions in accordance with aspects of the present disclosure.

FIGS. 16 and 17 show block diagrams of devices that support block based preamble design for autonomous uplink transmissions in accordance with aspects of the present disclosure.

FIG. 18 shows a block diagram of a communications manager that supports block based preamble design for autonomous uplink transmissions in accordance with aspects of the present disclosure.

FIG. 19 shows a diagram of a system including a device that supports block based preamble design for autonomous uplink transmissions in accordance with aspects of the present disclosure.

FIGS. 20 through 23 show flowcharts illustrating methods that support block based preamble design for autonomous uplink transmissions in accordance with aspects of the present disclosure.

### DETAILED DESCRIPTION

Some wireless communications systems may support multiple access techniques for multiple users by sharing available system resources (e.g., time, frequency, and power). In some cases, non-orthogonal multiple access (NOMA) techniques may outperform orthogonal multiple access techniques for some types of transmissions. NOMA techniques may enable access to more system bandwidth for transmitting devices (e.g., a user equipment (UE)), while simultaneously enabling a greater number of users to communicate on a set of time frequency resources.

Some wireless communications systems may support autonomous communications. Autonomous uplink communications may be utilized by systems that support machine type communication (MTC), or massive MTC (mMTC), where a base station serves a large number of UEs. In such cases, signals from multiple transmitting devices may be recovered simultaneously, even in the presence of mutual interference.

In some cases, a base station may be capable of receiving autonomous uplink transmissions (e.g., autonomous control channel transmissions, autonomous data channel transmissions, random access channel (RACH) transmissions,) from a large number of UEs. In such examples, the base station may detect a preamble from a UE and determine that the UE is transmitting on resources designated for autonomous uplink transmissions based on the preamble. However, in cases where multiple UEs are transmitting preambles on the same set of resources, it may be difficult or impossible for the base station to determine which UE is transmitting, or to successfully receive a transmission from the UE, if the simultaneous transmissions are too similar. Current preamble sequence lengths (e.g., for RACH type transmissions) may be too small to support a large number of UEs transmitting on autonomous uplink transmissions resources. However, increasing sequence length may be inefficient or deteriorate performance when fewer UEs are served by the cell. Thus, efficient preamble design for autonomous uplink transmissions may serve to optimize network performance.

In some examples, a base station may designate resources for autonomous uplink transmission. The designated resources may include a pool of blocks of resources for transmitting preambles prior to sending autonomous uplink data transmissions, which may be referred to as preamble blocks. A UE may send a preamble to a base station over a set of preamble blocks. However, as described above, when multiple devices transmit preambles over the same resources, it may be difficult to successfully receive the transmission at the base station if the sequences are too similar. Thus, if a preamble block pool is small, or if the sequences transmitted over the preamble blocks of the preamble block pool by multiple UEs are too similar, successful reception of the preambles may be less likely. Increasing a number of preamble blocks and ensuring that sequences identified or selected for transmission over the preamble blocks are sufficiently different may allow a wireless communication system to operate with more efficiency and support a scalable number of autonomous uplink transmission capable UEs. In some cases, a base station may configure a number of preamble blocks based on the number of UEs in a geographic coverage area (e.g., served by the cell).

A base station may assign a UE a set of preamble blocks from the preamble block pool. The UE may then determine a sequence from a sequence pool to transmit over the set of preamble blocks (e.g., one sequence for each preamble block of the set of preamble blocks). The sequences may be indexed, and the UE may identify (e.g., select) an index for each preamble block and apply the indices to the indexed sequence pool to determine which sequences to transmit over the set of preamble blocks. In some cases, the UE may identify one or more parameters, and the indices may be based on the parameters or selected randomly. The parameters may be known (e.g., a UE identifier, a cell identifier, a timing index, or the like). Additionally, or alternatively, the UE may receive an indication of the one or more parameters from the base station (e.g., via downlink control information (DCI) signaling or radio resource control (RRC) signaling, or a combination thereof).

To increase the difference between the parameters, the UE may perform an encoding procedure on the set of parameters, which may result in a series of indices. Performing the encoding procedure may increase the hamming distance between the series of indices or decrease cross correlation between identified sequences for transmission on preamble blocks. For instance, the UE may represent a set of parameters as a bit stream, divide the bit stream into substreams, and perform a stream encoding operation on the substreams. The UE may obtain a set of indices from the encoded substreams. The UE may apply the obtained indices to the sequence pool, and may map the set of sequences to the set of preamble blocks. In such examples, the set of sequences may be sufficiently different from each other so that the base station can simultaneously receive a preamble from a first UE and a preamble from a second UE on the same or overlapping set of preamble blocks. That is, the encoding procedure performed on the set of parameters may result in a set of indices that are sufficiently different to minimize cross correlation between the preambles of multiple UEs.

In some examples, the encoding procedure may include representing the parameters as a single bit stream and encoding the bit stream. The UE may then divide the encoded bit stream into multiple encoded substreams. The UE may obtain the set of indices from the encoded substreams. In some examples, the UE may interleave and scramble the bit stream before encoding the bit stream, before dividing the encoded bit stream into multiple encoded substreams, or both.

Aspects of the disclosure are initially described in the context of a wireless communications system. Aspects of the disclosure are further illustrated by and described with reference to preamble block assignment schemes, dynamic autonomous uplink transmission schedules, encoding procedures, subframe structures, and process flows. Aspects of the disclosure are further illustrated by and described with reference to apparatus diagrams, system diagrams, and flowcharts that relate to block based preamble design for autonomous uplink transmissions.

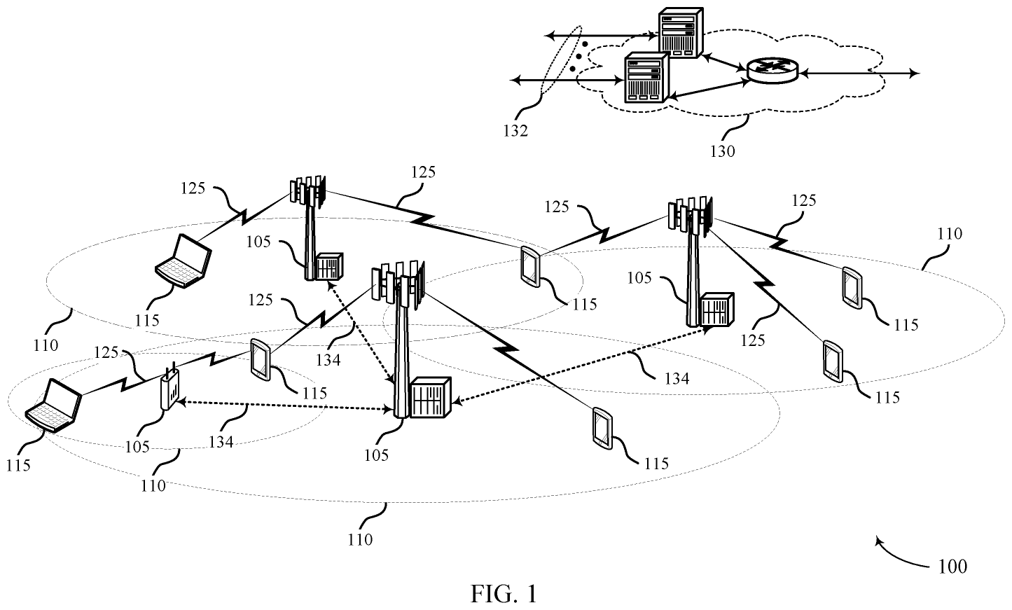

FIG. 1 illustrates an example of a wireless communications system 100 that supports block based preamble design for autonomous uplink transmissions in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the RRC protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{g}=307,200 Ts. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

In a system employing multicarrier modulation (MCM) techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

In some examples, a base station 105 may assign a set of preamble blocks for autonomous uplink transmissions from a preamble block pool. A UE 115 may identify indices for each of a set of indexed sequences to be transmitted over the set of preamble blocks. UE 115 may identify (e.g., select) the indices by performing an encoding procedure on a set of parameters. The indices may be applied to the pool of indexed sequences, and the resulting set of sequences may be transmitted over the set of assigned preamble blocks. The base station 105 may recognize composite sequences transmitted from UEs 115 on respective sets of preamble blocks based on the set of sequences. Thus, the base station 105 may identify a data transmission from the UE 115 based on monitoring for and identifying the set of sequences transmitted on the preamble blocks. An advantage of assigning a set of preamble blocks for autonomous uplink transmissions from a preamble block pool, recognizing composite sequences transmitted from the UEs 115 on respective sets of preamble blocks based on the set of sequences, and identifying data transmissions based on the monitoring may be increased efficiency for autonomous uplink transmissions that may serve to optimize network performance, decrease collisions, enhance scalability of a number of served UEs 115, and improve user experience.

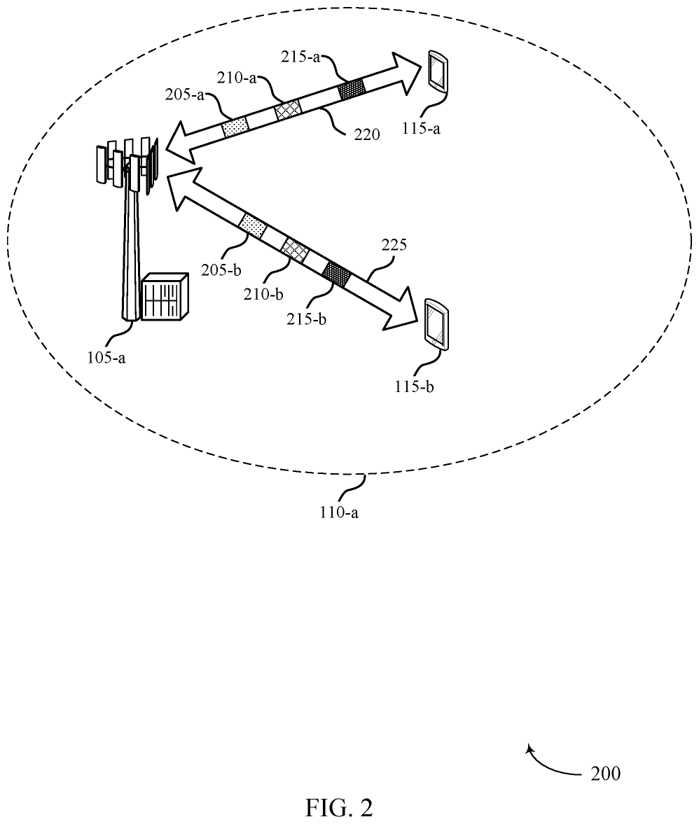

FIG. 2 illustrates an example of a wireless communications system 200 that supports block based preamble design for autonomous uplink transmissions in accordance with aspects of the present disclosure. In some examples, wireless communications system 200 may implement aspects of wireless communication system 100. In some cases, wireless communications system 200 may include one or more base stations 105 or UEs 115, which may implement autonomous uplink transmissions between a UE 115 and a base station 105. Base stations 105 and UEs 115 may be examples of the devices as described with reference to FIG. 1.

Base station 105-a may serve a large number of UEs 115. UE 115-a and UE 115-b, for example, may be autonomous uplink transmission capable UEs 115. UE 115-a and UE 115-b may send autonomous uplink transmissions (e.g., control messages, data messages, random access messages for two-part RACH or four-part RACH procedures, or the like) via bidirectional communication links 220 and 225, respectively. Base station 105-a may designate resources for autonomous uplink transmissions from any UE 115 within geographic coverage area 110-a. In some examples, UE 115-a may utilize the designated resources to transmit a preamble 205-a and a data transmission 215-a. UE 115-a may also transmit a demodulation reference signal (DMRS) 210-a. Base station 105-a may determine that UE 115-a is transmitting based on preamble 205-a, and may receive DMRS 210-a and data transmission 215-a.

Base station 105-a may assign, on bidirectional communication links 220 and 225, a set of preamble blocks. In some cases, base station 105-a may configure a preamble block pool for transmitting preambles 205. Base station 105-a may assign respective sets of preamble blocks from the preamble block pool to UE 115-a or UE 115-b. Preamble blocks may be mapped to physical resources and sequences that make up the preamble may be transmitted over the mapped physical resources. Preamble blocks may be aligned (e.g., in frequency, in time) with resource blocks of DMRS 210 and data transmissions 215, or may not be aligned with the resource blocks of DMRS 210 and data transmission 215. In some cases, the preamble blocks may be the same size or may be different sizes, the resources of the preamble blocks of the preamble block pool may overlap in part or may not overlap at all, may be located on consecutive time resources or consecutive frequency resources, or may be interleaved across multiple time resources or frequency resources.

In some examples, multiple UEs in geographic coverage area 110-a (e.g., UE 115-a and UE 115-b) may be assigned a set of preamble blocks that are partially or completely overlapping. In such cases, UE 115-a and UE 115-b may transmit preamble 205-a and preamble 205-b on the same resources. In some examples, the sequence length of preamble 205-a and preamble 205-b may be small in comparison to the number of UEs transmitting. In such cases, when a large number of UEs are transmitting preambles on the same resources, more than one UE 115 may identify or select the same or very similar sequences or sets of sequences for transmitting preambles 205. When multiple similar or same sequences are transmitted by a number of UEs 115, base station 105-a may not be able to successfully receive one or both of preamble 205-a and preamble 205-b, or other preambles 205 transmitted by other UEs 115. If base station 105-a cannot receive one or both of preamble 205-a or preamble 205-b, base station 105-a may not be able to determine which UE 115 is transmitting the received signals, and may not successfully receive one or both of DMRS 210 and data transmissions 215.

In some examples, a base station 105-a may serve a changeable number of UEs 115 and improve reception of autonomous uplink transmission through expandable preamble block allocation. That is, in the case described above where multiple UEs 115 transmit preambles using a small number of sequences, a base station may improve service and increase the number of successfully received transmissions by increasing the number of assigned preamble blocks (and increasing the total number of possible composite sequences UEs 115 may transmit over the increased number of preamble blocks). Base station 105-a may consider multiple factors in determining a number of preamble blocks to assign. For instance, base station 105-a may assign a smaller number of preamble blocks to each UE 115 when fewer UEs 115 are supported or served by the cell. When the number of UEs 115 supported or served by the cell increases, base station 105-a may increase the number of assigned preamble blocks. Base station 105-a may also consider other factors. For instance, UE 115-a may be power limited, and UE 115-b may not be power limited. In such examples, base station 105-a may assign few preamble blocks to UE 115-a and more preamble blocks to UE 115-b. UE 115-a, for example, may select a set of sequences for transmission over the set of preamble blocks.

UE 115-a may identify a set of parameters, which may include one or more of a cell identifier, a UE identifier, a timing index, a parameter received via DCI signaling or RRC signaling, a randomly selected parameter, or a combination. UE 115-a may apply an encoding procedure to the parameters, and may obtain a set of indices based on the procedure. The encoding procedure may amplify any difference between the parameters of UE 115-a and the parameters of UE 115-b and spread the differences to selection of each of the set of indices. Upon obtaining the indices, UE 115-a and UE 115-b may apply the indices to a pool of indexed sequences, and may map the resulting set of sequences to the assigned set of preamble blocks. UE 115-a may transmit preamble 205-a by transmitting the set of sequences over the set of preamble blocks. UE 115-b may similarly transmit preamble 205-b by transmitting the set of sequences over the set of preamble blocks assigned by base station 105-a. As a result of the indices obtained by the encoding procedure, preamble 205-a and preamble 205-b may be distinguishable from one another and from any other preambles being transmitted by a large number of UEs 115 by base station 105-a. That is, the set of sequences transmitted over the set of preamble blocks by UE 115-a may be distinct from the set of sequences transmitted over the set of preamble blocks by UE 115-b based on the indices selected by each UE 115. Thus, even when UE 115-a and UE 115-b transmit sequences over the same preamble blocks, base station 105-a may determine which UEs 115 are transmitting, and may successfully receive preambles 205, DMRSs 210, and data transmissions 215.

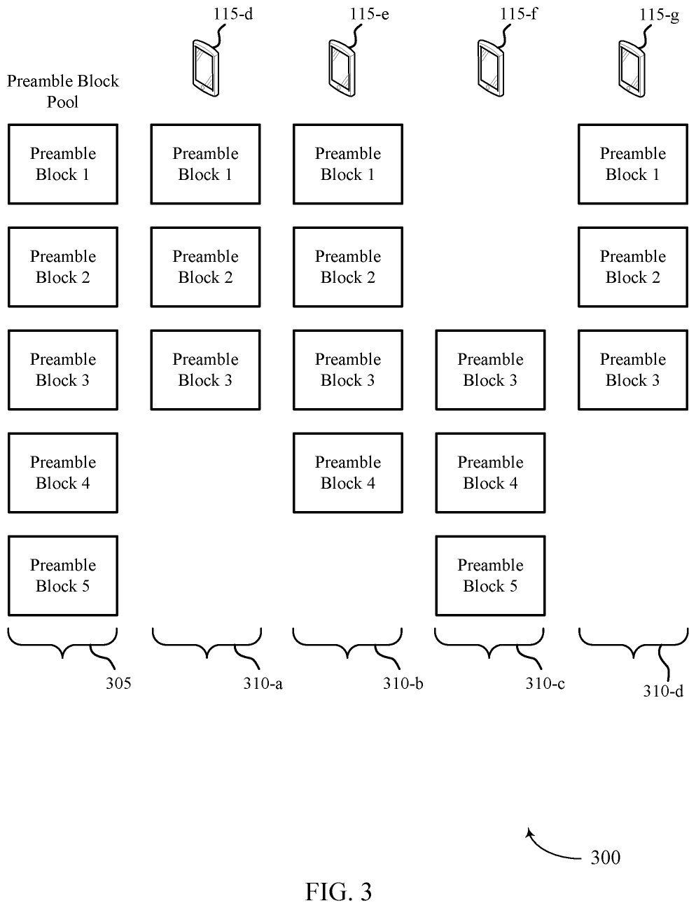

FIG. 3 illustrates an example of a preamble block assignment scheme 300 that supports block based preamble design for autonomous uplink transmissions in accordance with aspects of the present disclosure. In some examples, preamble block assignment scheme 300 may implement aspects of wireless communication system 100. Preamble block assignment scheme 300 may be implemented by one or more base station 105 or a UE 115, which may be examples of the devices as described with reference to FIGS. 1 and 2.

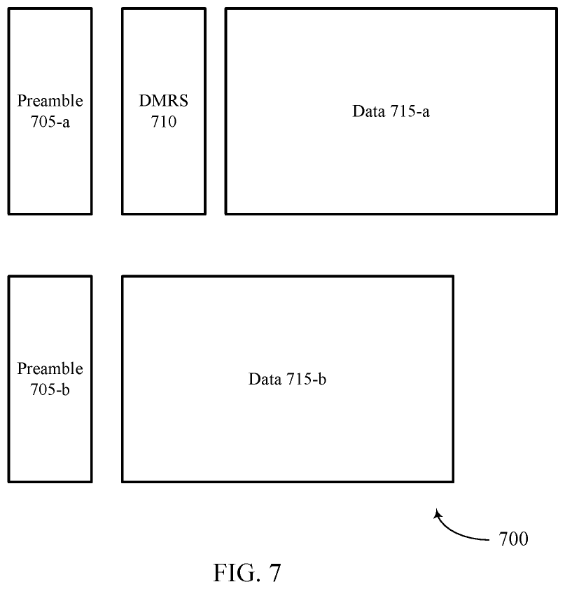

In some examples, a base station may assign preamble blocks from a preamble block pool 305 to one or more UEs 115. A base station 105 may assign resources for the preamble blocks of the preamble block pool 305, or preamble block pool 305 may be preconfigured for a base station 105 and UEs 115. Preamble blocks may be associated with resource block allocations for DMRS and data transmissions (e.g., preamble blocks may be aligned or unaligned with resource block allocations for DMRS and data transmissions), and preamble block allocation may be different across preamble symbols or may be the same, as described in greater detail with respect to FIGS. 7-10.

A UE 115 may transmit a preamble to a base station 105 (e.g., prior to an autonomous uplink data transmission, as part of a first message of a two-step random access message, as a first message of a four-step random access message, or the like), and the preamble may be transmitted over multiple preamble blocks. Base station 105 may assign sets of preamble blocks to UEs 115 from preamble block pool 305. For example, preamble block pool 305 may include preamble blocks 1-5. Base station 105 may assign a first set of preamble blocks 310-a (e.g., preamble blocks 1-3) to UE 115-d, a second set of preamble blocks 310-b (e.g., preamble blocks 1-4) to UE 115-e, a third set of preamble blocks 310-c (e.g., preamble blocks 3-5) to UE 115-f, and a fourth set of preamble blocks 310-d (e.g., preamble blocks 1-3) to UE 115-g. Base station 105 may assign the same number of preamble blocks to multiple UEs 115 (e.g., base station 105 may assign three preamble blocks to each of UE 115-d, UE 115-f, and UE 115-g) or may assign a different number of preamble blocks to multiple UEs 115 (e.g., base station 105 may assign three preamble blocks to UE 115-d and may assign four preamble blocks to UE 115-e). In some cases, base station 105 may assign the same set of preamble blocks to multiple UEs 115 (e.g., base station 105 may assign preamble blocks 1-3 to UE 115-d and UE 115-g). In some cases, base station 105 may assign sets of preamble blocks 310 to UEs 115 such that portions of the sets of preamble blocks 310 overlap (e.g., preamble blocks 1-4 are assigned to UE 115-e, and preamble blocks 3-5 are assigned to UE 115-f, so preamble blocks 3 and 4 are assigned to both UE 115-e and UE 115-f).

In some examples, base station 105 may serve a changeable number of UEs 115 and improve reception of autonomous uplink transmission through expandable preamble block allocation. That is, in the case described above where multiple UEs 115 transmit preambles using a small number of sequences, a base station may improve service and increase the number of successfully received transmission by increasing the number of assigned preamble blocks (and increasing the total number of possible composite sequences UEs 115 may transmit over the increased number of preamble blocks). Base station 105 may consider multiple factors in determining a number of preamble blocks to assign. For instance, base station 105 may assign a smaller number of preamble blocks to each UE 115 when fewer UEs 115 are supported or served by the cell. When the number of UEs 115 supported or served by the cell increases, base station 105-a may increase the number of assigned preamble blocks. For example, when fewer UEs 115 are served by base station 105, base station 105 may decrease the number of preamble blocks assigned to each of UE 115-d, UE 115-e, UE 115-f, and UE 115-g. Base station 105-a may also consider other factors. For instance, UE 115-d may be power limited, and UE 115-e may not be power limited. In such examples, base station 105-a may assign fewer preamble blocks to UE 115-d (e.g., three or less preamble blocks) and more preamble blocks to UE 115-e (e.g., four or more preamble blocks).

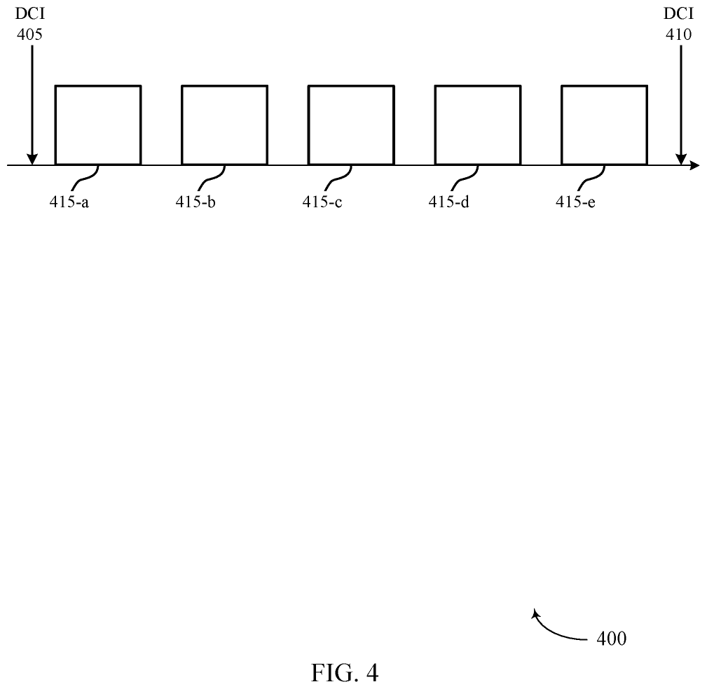

Base station 105 may assign the sets of preamble blocks to UEs 115 statically, semi-statically, or dynamically. For instance, base station 105 may assign the sets of preamble blocks from preamble block pool 305 via system information (SI) such as a system information block (SIB). For example, SI may indicate whether a predetermined scheme (e.g., hashing) is to be used. The SI may further indicate a set of parameters (e.g., a number of blocks, a hashing scheme, etc.). In some examples, an SI may indicate that a set of parameters for a predetermined scheme may be subsequently indicated via a different signal (e.g., via RRC signaling). Additionally, or alternatively, UE 115 may assign the sets of preamble blocks via RRC signaling. In some cases, base station 105 may assign the sets of preamble blocks via DCI, as shown in greater detail with respect to FIG. 4. In some examples, preamble block assignments may be made via a combination of static, semi-static, and dynamic signaling.

FIG. 4 illustrates an example of a dynamic autonomous uplink transmission schedule 400 that supports block based preamble design for autonomous uplink transmissions in accordance with aspects of the present disclosure. In some examples, dynamic autonomous uplink transmission schedule 400 may implement aspects of wireless communication system 100. Aspects of dynamic autonomous uplink transmission schedule 400 may be implemented by one or more base station 105 or UEs 115, which may be examples of the devices as described with reference to FIGS. 1 and 2.

In some examples, a base station 105 may assign a set of preamble blocks from a preamble block pool to a UE 115 via dynamic signaling. For example, base station 105 may include an indication in a first DCI 405 that indicates the start of an autonomous uplink transmission period. A subsequent DCI signal, such as DCI 410, may include an indication of the end of the autonomous uplink transmission period.

In an illustrative example, base station 105 may transmit DCI 405 to a UE 115. DCI 405 may indicate the beginning of an autonomous uplink transmission period. The autonomous uplink transmission period may include an open set of resources for autonomous uplink transmission that comprise multiple transmission opportunities 415 (e.g., transmission time intervals (TTIs)) from the reception of first DCI 405 to the reception of second DCI 410. In some examples, the autonomous uplink transmission period may include a series of consecutive transmission opportunities 415. During each transmission opportunity subsequent to DCI 405, UE 115 may (e.g., when it has mobile originated (MO) data to send) send uplink transmissions (e.g., autonomous control channel transmissions, autonomous data channel transmissions, random access messages for two-step RACH or four-step RACH procedures, or the like).

DCI 405 may also include an assignment of a set of preamble blocks from a preamble block pool. During any transmission opportunity 415 subsequent to DCI 405, UE 115 may transmit a preamble on the assigned set of preamble blocks or a set of preamble blocks derived from the assigned set of preamble blocks (e.g., cyclically shifted). Base station 105 may transmit a DCI 410 indicating the end of the autonomous transmission opportunities. Subsequent to receiving DCI 410, UE 115 may not send any autonomous uplink transmissions until UE 115 receives another DCI 405 indicating the initiation of another autonomous uplink transmission period. Another DCI 405 may include a new assignment (or a reiteration of the old assignment) of a set of preamble blocks from the preamble block pool.

In some examples, UEs 115 may perform autonomous uplink transmissions without a trigger or initiation indication from a DCI 405. For instance, other signaling (e.g., RRC signaling or SI signaling) may configure a set of resources (e.g., for a control channel, data channel, or PRACH) for autonomous uplink transmissions by a set of UEs 115 served by a cell. In some cases, UEs may be preconfigured to be capable of sending autonomous uplink transmissions on certain resources or during certain transmission opportunities. Autonomous uplink transmissions maybe referred to as grant-free transmissions in some cases. A UE 115 may receive an indication such as DCI 405 or another downlink signal that opens up a set of transmission opportunities 415. However, a first UE 115 may share the set of transmission opportunities 415, and may only elect to send an autonomous uplink transmission when it actually has data to send.

As an illustrative example, a first UE 115 and a second UE 115 (along with a large number of other UEs) may receive DCI 405, opening the set of transmission opportunities 415. First UE 115 may have nothing to transmit and may refrain from sending an autonomous uplink transmission during transmission opportunity 415-a, but second UE 115 may have data to send, and may send an autonomous uplink transmission during transmission opportunity 415-a. During transmission opportunity 415-b, first UE 115 may have data to send and may send an autonomous uplink transmission, while second UE 115 may have no data to send and may refrain from sending an autonomous uplink transmission. During transmission opportunity 415-c, both first UE 115 and second UE 115 may have data to send, and both UEs 115 may send an autonomous uplink transmission during transmission opportunity 415-c.

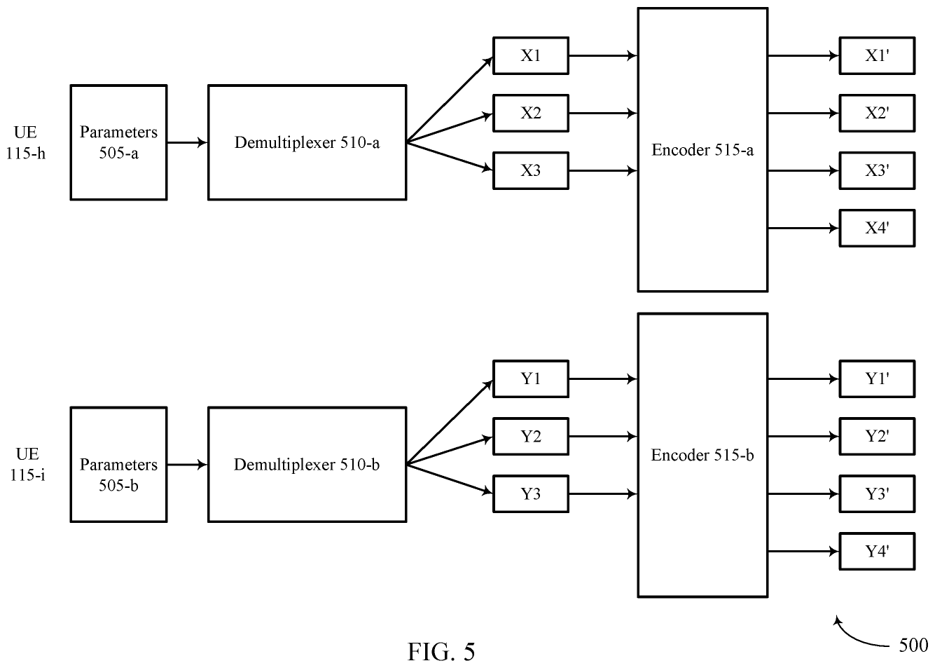

FIG. 5 illustrates an example of an encoding procedure 500 that supports block based preamble design for autonomous uplink transmissions in accordance with aspects of the present disclosure. In some examples, encoding procedure 500 may implement aspects of wireless communication system 100. Encoding procedure 500 may be implemented by one or more base stations 105 or UEs 115, which may be examples of the devices as described with reference to FIGS. 1 and 2.

As described above, a base station 105 may assign, to a UE 115, a set of preamble blocks from a preamble block pool for transmitting a preamble to the base station 105. In such examples, the UE 115 may transmit one or more identified (e.g., selected) sequences on the assigned set of preamble blocks. The preamble block pool may be associated with a pool of indexed sequences. The sequence pool may include a number of indexed sequences. The size of each preamble block of the preamble block pool may be equal to the length of each sequence in the sequence pool, so that any indexed sequence from the sequence pool could be transmitted over any preamble block from the set of preamble blocks. Sequences may be for example, Zadoff-Chu sequences with a respective root and cyclic shift. Sequences may be Gold sequences with a respective initial register status, Galois sequences, orthogonal basis sequence, or any combination thereof. Orthogonal bases sequences may be for example, Fourier basis, Hadamard sequences, or single tone sequences (e.g., a sequence with a single non-zero value in a set of values). The sequence pool may be statically configured (e.g., via SI signaling) semi-statically configured (e.g., via RRC signaling), dynamically configured (e.g., via DCI signaling) or may be configured via a combination thereof If a sequence pool size is equal to M, and a UE is assigned N preamble blocks, then the total number of available sequences for transmitting a preamble is M^{N}.

A UE 115 that is assigned a set of preamble blocks and a pool of sequences may determine which sequence from the sequence pool to transmit over each preamble block. For instance, UE 115-h and UE 115-i may be configured with four preamble blocks each, and may each identify four sequence indices to select a set of four sequences for transmission over the four preamble blocks.

UE 115 may select indices based on a set of parameters, or may randomly (e.g., pseudo-randomly) select indices. Parameters may be known to UE 115-h and a serving base station 105. For example, the set of parameters may include one or more of a cell identifier, a UE identifier, a timing index, or the like. In some examples, base station 105 may configure UE 115-h with parameters via RRC signaling, DCI signaling, or the like. Base station 105 may know the set of parameters, and may thus identify a transmitting UE 115-h when UE 115-h transmits a preamble based on the known parameters.

UE 115-h may identify parameters 505-a, and may perform an encoding procedure on parameters 505-a. The encoding procedure may result in a set of indices (X1′, X2′, . . . , XN′) for UE 115-h. The same encoding procedure may result in indices (Y1′, Y2′, . . . , YN′) for UE 115-i. Parameters 505-a and parameters 505-b may be similar in some cases. However, applying the encoding procedure may amplify any differences between parameters 505-a and parameters 505-b so that indices (X1′, X2′, . . . , XN′) and indices (Y1′, Y2′, . . . , YN′) are different enough to increase the likelihood or ensure that the set of sequences transmitted over the set of preamble blocks are distinguishable by base station 105. For instance, UE 115-h may apply the encoding procedure to maximize the distance between the preamble transmitted by UE 115-h over the set of preamble blocks based on indices (X1′, X2′, . . . , XN′) and the preamble transmitted by UE 115-I based on indices (Y1′, Y2′, . . . , YN′). The encoding procedure may also avoid scenarios in which a sequence transmitted by UE 115-h and a sequence transmitted by UE 115-i are identical, nearly identical, or so similar that base station 105 is unable to detect which of UE 115-h and 115-i is transmitting the sequences. The encoding procedure may minimize cross correlation between the final preamble sequences based on indices (X1′, X2′, . . . , XN') and indices (Y1′, Y2′, . . . , YN′). For example, encoding procedure may maximize a hamming distance between indices (X1′, X2′, . . . , XN′) and indices (Y1′, Y2′, . . . , YN′).

The encoding procedure may include demultiplexing a bit stream representing parameters 505, and encoding substreams of the bit stream. In some examples, UE 115-h may include a demultiplexer 510-a. UE 115-e may represent parameters 505-a as a bit stream. Demultiplexer 510-a may divide the bit stream into substreams X1, X2, and X3. UE 115-h may also include an encoder 515-a. Encoder 515-a may perform a stream encoding operation on substreams X1, X2, and X3. Encoder 515-a may generate a set of encoded substreams (e.g., indices X1′, X2′, X3′, and X4′). The number of indices may be equal to the number of preamble blocks in the set of assigned preamble blocks. If base station 105 assigns four preamble blocks to UE 115-h, then encoder 515-a may generate four indices (indices X1′, X2′, X3′, and X4′). UE 115-h may apply the generated indices to the pool of indexed sequences (e.g., map each encoded substream to a respective one of the pool of indexed sequences). Similarly, UE 115-i may identify parameters 505-b, represent parameters 505-b as a bit stream, divide the bit stream into multiple substreams Y1, Y2, and Y3, with demultiplexer 510-b, and perform a stream encoding operation on the substreams with encoder 515-b to generate indices Y1′, Y2′, Y3′, and Y4′. In some examples, parameters 505-a and parameters 505-b may be similar (e.g., some of the parameters may be the same, and some may only differ by a small number of bits). However, the stream encoding operations of encoder 515-a and 515-b may expand those difference to increase a hamming distance between indices X1′, X2′, X3′, and X4′ and indices Y1′, Y2′, Y3′, and Y4′. Thus, when UE 115-h applies indices X1′, X2′, X3′, and X4′ to the sequence pool to identify a set of sequences, and when UE 115-i applies indices Y1′, Y2′, Y3′, and Y4′ to the sequence pool to identify a set of sequences, the resulting set of sequences transmitted on the set of preamble blocks by UE 115-h and the set of sequences transmitted on the set of preamble blocks by UE 115-i may be distinct. Base station 105 may be able to receive the preamble from UE 115-h and determine that UE-115-h is transmitting, and may similarly determine that UE 115-i is transmitting based on its transmitted preamble.

In some examples, encoder 515-a may, as part of the stream encoding operation, map each of substreams X1, X2, and X3 to a set of numbers of a first dimension (e.g., a Galois field). In some examples, encoder 515-a may also encode the mapped substreams X1, X2, and X3 according to a generator matrix to obtain the encoded substreams (indices X1′, X2′, X3′, and X4′). In some examples, an output dimension of the generator matrix may correspond to a number of preamble blocks in the set of preamble blocks. As an illustrative example, UE 115-h may perform Reed-Solomon coding (e.g., via encoder 515-a). In such examples, encoder 515-a may map the T binary substreams X1, X2, and X3, (e.g., where T=3) to T=3 numbers in a Galois Field P (e.g., which may have dimension R). The numbers in the Galois Field P may be denoted as B, where B={b1, b2, . . . , bT}. In some examples, the encoding operation may include encoding by multiplication, where the resulting encoded E=G×B, and the size of the coding matrix is N×T where N is equal to the number of outputs (e.g., number of indices X1′, X2′, X3′, and X4′), which may be equal to the number of preamble blocks. In such examples, UE 115-h may map the N outputs of E within the pool of sequences to identify a set of sequences for transmitting on the set of preamble blocks. For example, the encoding matrix G may include a Vandermonde matrix, a sparse matrix, or the like.

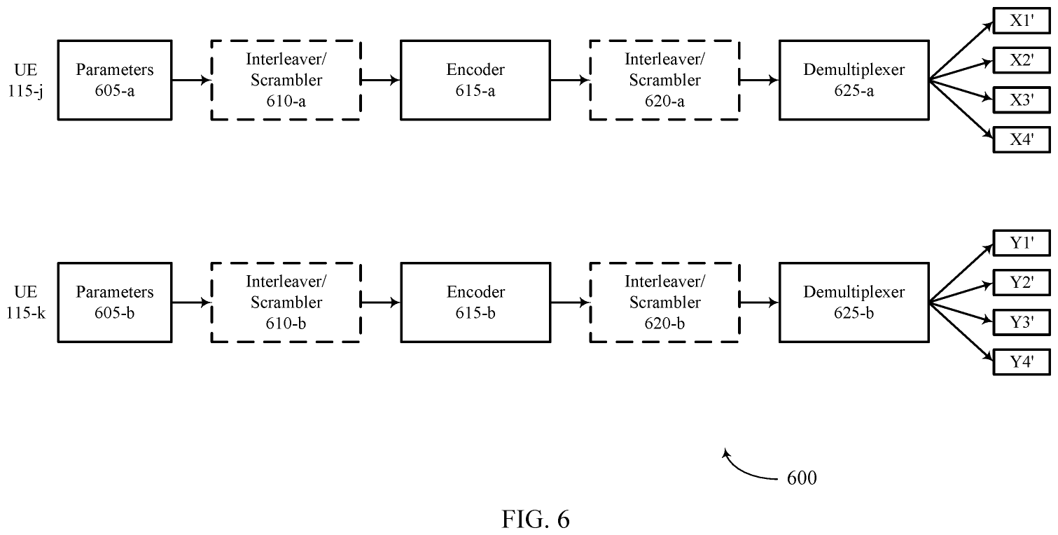

FIG. 6 illustrates an example of an encoding procedure 600 that supports block based preamble design for autonomous uplink transmissions in accordance with aspects of the present disclosure. In some examples, encoding procedure 600 may implement aspects of wireless communication system 100. Encoding procedure 600 may be implemented by one or more base stations 105 or UEs 115, which may be examples of the devices as described with reference to FIGS. 1 and 2.

As described above, a base station 105 may assign, to a UE 115, a set of preamble blocks from a preamble block pool for transmitting a preamble to the base station 105. In such examples, the UE 115 may transmit one or more identified sequences on the assigned set of preamble blocks. The preamble block pool may be associated with a pool of indexed sequences. Sequences may be for example, Zadoff-Chu sequences with a respective root and cyclic shift. Sequences may be Gold sequences with a respective initial register status, Galois sequences, orthogonal basis sequence, or any combination thereof. The sequence pool may be statically configured (e.g., via SI signaling) semi-statically configured (e.g., via RRC signaling), dynamically configured (e.g., via DCI signaling) or may be configured via a combination thereof. If a sequence pool size is equal to M, and a UE is assigned N preamble blocks, then the total number of available sequences for transmitting a preamble is M^{N}.

A UE 115 that is assigned a set of preamble blocks and a pool of sequences may determine which sequence from the sequence pool to transmit over each preamble block. For instance, UE 115-j and UE 115-h may be configured with four preamble blocks each, and may each identify four sequence indices to select a set of four sequences for transmission over the four preamble blocks.

A UE 115 may identify (e.g., select) indices based on a set of parameters or may randomly select indices. Parameters may be known to UE 115-j and a serving base station 105. For example, the set of parameters may include one or more of a cell identifier, a UE identifier, a timing index, or the like. In some examples, base station 105 may configure UE 115-j with parameters via RRC signaling, DCI signaling, or the like. Base station 105 may know the set of parameters, and may thus identify a transmitting UE 115-h when UE 115-h transmits a preamble based on the known parameters.

UE 115-j, for example, may identify parameters 605-a, and may perform an encoding procedure on parameters 605-a. The encoding procedure may result in a set of indices (X1′, X2′, . . . , XN') for UE 115-j. The same encoding procedure may result in indices (Y1′, Y2′, . . . , YN′) for UE 115-k. Parameters 605-a and parameters 605-b may be similar in some cases. However, applying the encoding procedure may amplify any differences between parameters 505-a and parameters 505-b. Determined indices (X1′, X2′, . . . , XN′) and indices (Y1′, Y2′, . . . , YN′) may be different enough to increase the likelihood or ensure that the set of sequences transmitted by UE 115-j and UE 115-k over the same set or overlapping sets of preamble blocks are distinguishable by base station 105, as described with respect to FIG. 5.

The encoding procedure may include encoding a bit stream representing parameters 605, and multiplexing the encoded bit stream into multiple encoded substreams. UE 115-j, for example, may identify parameters 605-a and may represent parameters 605-a as a bit stream. UE 115-a may include an encoder 615-a. Encoder 615-a may encode the bit stream and output a single encoded bit stream. UE 115-a may also include a demultiplexer 625-a. Demultiplexer 625-a may divide the encoded bit stream into a plurality of bit streams (e.g., indices X1′, X2′, X3′, and X4′. UE 115-j may apply the generated indices to the set of indexed sequences (e.g., map each encoded substream to a respective one of the set of indexed sequences). UE 115-k may perform a similar encoding procedure on parameters 605-b, resulting in indices Y1′, Y2′, Y3′, and Y4′.

In some examples, a UE 115 may also perform interleaving or scrambling on the bit stream representing parameters 605 or on the encoded bit stream as part of the encoding procedure. For instance, UE 115-j may include an interleaver/scrambler 610-a or an interleaver/scrambler 620-a, or both. Interleaver/scrambler 610-a may interleave or scramble the bit stream representing parameters 605-a prior to encoding the bit stream. In some examples, interleaver/scrambler 620-a may interleave or scramble the encoded bit stream prior to dividing the bit stream with demultiplexer 625-a. The interleaving and scrambling of the bit stream or the encoded bit stream or both may further decrease any correlation between indices X1′ X2′, X3′ and X4′, and Y1′ Y2′, Y3′, and Y4′.

In some examples, parameters 605-a and parameters 605-b may be similar (e.g., some of the parameters may be the same, and some may only differ by a small number of bits). However, the encoding procedure may expand those difference to increase a hamming distance between indices X1′, X2′, X3′, and X4′ and indices Y1′, Y2′, Y3′, and Y4′. Thus, when UE 115-j applies indices X1′, X2′, X3′, and X4′ to the sequence pool to identify a set of sequences, and when UE 115-k applies indices Y1′, Y2′, Y3′, and Y4′ to the sequence pool to identify a set of sequences, the resulting set of sequences transmitted on the set of preamble blocks by UE 115-h and the set of sequences transmitted on the set of preamble blocks by UE 115-i may have a Hamming distance that is substantially larger than the Hamming distance between the parameters 605-a and 605-b. Base station 105 may be able to receive the preamble from UE 115-j and determine that UE-115-j is transmitting, and may similarly determine that UE 115-k is transmitting based on its transmitted preamble.

In some examples, base station 105 may perform similar procedures on the set of known parameters. That is, a base station 105 may also use an interleaver/scrambler to interleave and scramble the bit stream representing the parameters, an encoder to encode the bit stream, an interleaver/scrambler to interleave or scramble the encoded bit stream, and a demultiplexer to divide the encoded bit stream into a set of encoded substreams. The base station 105 may perform the encoding procedure on the parameters 605-a to obtain the indices, and may apply the indices to the pool of indexed sequences. The base station 105 may thus know the set of sequences that UE 115-4 or UE 115-5 may transmit over the set of preamble blocks, and may monitor the preamble block pool for the set of sequences. In some examples, the base station 105 may work backwards to identify the known parameters 605 based on a detected set of sequences. In such examples, base station 105 may receive a preamble from a UE 115-j, multiplex received encoded substreams to generate a single encoded bit stream, deinterleave and unscramble the encoded substream, may decode the encoded substream, may deinterleave and unscramble the resulting bit stream, identify parameters 605-a based on the bit stream, and identify the corresponding UE 115-j based thereon.

FIG. 7 illustrates an example of a subframe structure 700 that supports block based preamble design for autonomous uplink transmissions in accordance with aspects of the present disclosure. In some examples, subframe structure 700 may implement aspects of wireless communication system 100. Subframe structure 700 may be utilized one or more base station 105 or a UE 115, which may be examples of the devices as described with reference to FIGS. 1 and 2.

In some examples, a UE 115 may transmit a preamble 705-a. For example, UE 115 may transmit preamble 705-a and an associated data message 715-a as an autonomous uplink transmission (e.g., may transmit preamble 705-a and data message 715-a simultaneously, or with an offset in time, frequency, or spatial resources). In some examples, UE 115 may transmit preamble 705-a and data message 715-a as a first message of a two-step RACH procedure. Alternatively, UE 115 may transmit preamble 705-a as a first message of a four-step RACH procedure, may receive a downlink message from a base station 105 as a second message, and may transmit data message 715-a as a third message of the four-step RACH procedure. UE 115 may, in some examples, transmit an associated DMRS 710, data message 715-a, or both, as autonomous uplink transmissions. As described above with respect to FIGS. 5 and 6, the UE 115 may identify a set of indices (e.g., randomly or based on a set of parameters) to identify a set of sequences from a pool of indexed sequences, and may transmit the set of sequences on a set of preamble blocks included in preamble 705-a.

In some cases, UE 115 may transmit DMRS 710. UE 115 may transmit DMRS concurrently with preamble 705-a (e.g., within a same TTI or one or more overlapping symbols) or after transmitting preamble 705-a (e.g., a subsequent symbol or TTI). UE 115 may identify a set of sequences for transmitting DMRS based on a set of parameters. In some cases, the set of parameters may be the same set of parameters used to identify the set of sequences for preamble 705-a. For instance, the set of parameters may include one or more of a cell identifier, a UE identifier, a timing index, or the like. In some examples, base station 105 may configure UE 115 with the set of parameters via RRC signaling, DCI signaling, or the like. In some examples, a base station 105 may additionally or alternatively use DMRS 710 for detecting autonomous uplink transmissions from the UE 115. As discussed in greater detail with respect to FIGS. 2, 5, and 6, a base station may determine that UE 115 is transmitting based on a set of sequences transmitted over a set of preamble blocks. However, base station 105 may perform the same or similar methods on DMRS 710. That is, UE 115 may identify a set of sequences for transmitting DMRS 710 based on the set of parameters, and base station 105 may identify the transmission of DMRS 710 and an associated (e.g., subsequent) transmission of data message 715-a based on receiving the set of sequences. In some examples, the base station may attempt to determine that UE 115 is transmitting based on the preamble 705-a, and DMRS 710 may serve as a fall back, allowing base station 105 to detect the transmission from UE 115 based on DMRS 710 even if it fails to detect preamble 705-a. In some cases, base station 105 may determine that UE 115 is transmitting based on DMRS 710 instead of based on preamble 705-a. In other cases, UE 115 may transmit preamble 705-b, and data message 715-b, and may not transmit a DMRS.

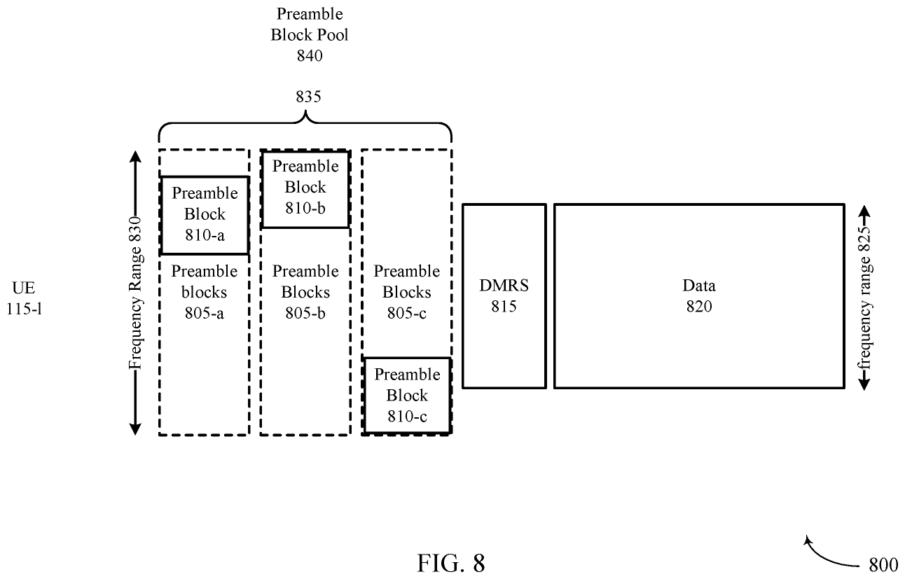

FIG. 8 illustrates an example of a subframe structure 800 that supports block based preamble design for autonomous uplink transmissions in accordance with aspects of the present disclosure. In some examples, subframe structure 800 may implement aspects of wireless communication system 100. Subframe structure 800 may be used by one or more base stations 105 or UEs 115, which may be examples of the devices as described with reference to FIGS. 1 and 2.

As described in greater detail with respect to FIG. 3, a base station may allocate a preamble block pool 840, and may assign preamble blocks 810 to specific UEs 115. In some examples, the preamble block pool 840 may correspond to a total set of resource blocks that span a set of TTIs 835 (e.g., 3 symbols) and frequency range 830 (e.g., preamble block 805-a preamble block 805-b, and preamble block 805-c). Base station 105 may assign a set of preamble blocks to UE 115-l from preamble block pool 840.

In some examples, resource block allocation of assigned preamble blocks 810-b may not correspond to resource block allocation for DMRS 815 and Data 820. For instance, resource blocks for DMRS 815 and data 820 may span frequency Range 825, which may be less than preamble block pool 840. In such instances, a preamble block 810 assigned to UE 115-l may be located at or near the upper boundary of frequency range 830, and may not align with the upper boundary of frequency range 825. Similarly, preamble block 810-c may be located at or near the lower boundary of frequency range 830, which may not align with the lower boundary of frequency range 825.

In some examples, resource block allocation of assigned preamble blocks 810 may span multiple TTIs 835 (e.g., across multiple symbols). For instance, base station 105 may assign preamble block 810-a in a first symbol to UE 115-l, preamble block 810-b in a second symbol to UE 115-l, and preamble block 810-c in a third symbol to UE 115-l.

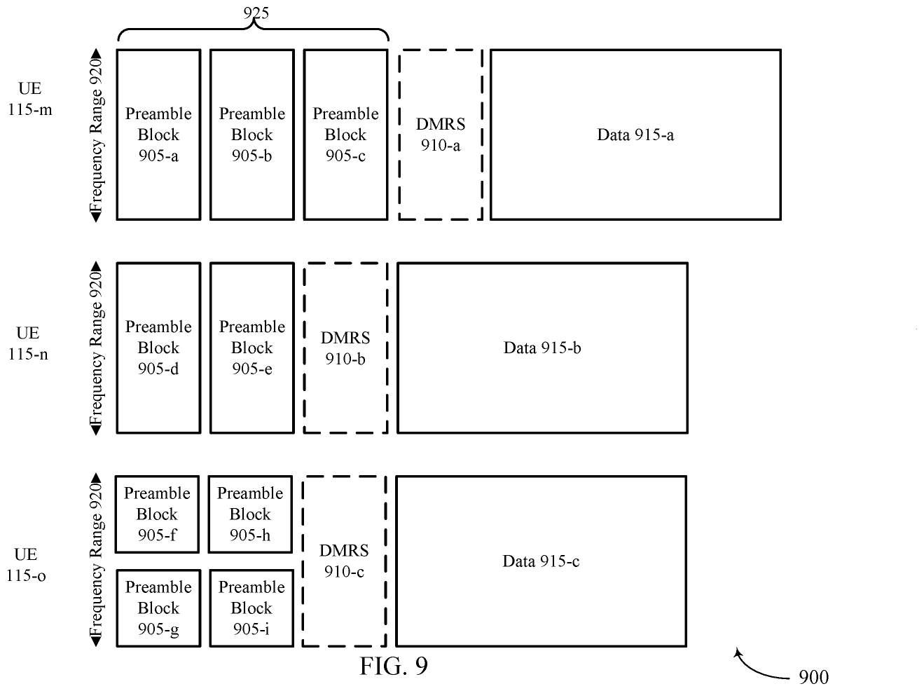

FIG. 9 illustrates an example of a subframe structure 900 that supports block based preamble design for autonomous uplink transmissions in accordance with aspects of the present disclosure. In some examples, subframe structure 900 may implement aspects of wireless communication system 100. Subframe structure 900 may be used by one or more base stations 105 or UEs 115, which may be examples of the devices as described with reference to FIGS. 1 and 2.

In some examples, as described above, a base station 105 may assign preamble blocks 905 to UEs 115 from a pool of preamble blocks. In some examples, the preamble block pool may include a frequency range and a set of TTIs, configured by the base station 105. For example, a preamble block pool may be defined by frequency range 920 and a set of TTIs 925 (e.g., three symbols).

In some examples, resource blocks of the preamble block pool and the preamble blocks 905 of the preamble block pool may align with the resource blocks of DMRS 910 and data 915. For instance, UE 115-m may be assigned preamble blocks 905-a, 905-b, and 905-c, each of which may include resource blocks that comprise one symbol in time and frequency resource equal to frequency range 920. UE 115-n may be assigned preamble block 905-d and preamble block 905-e, both of which may include resource blocks that align with the resource blocks of DMRS 910-b and Data 915-b. As described in greater detail with respect to FIG. 7, a UE 115 may transmit DMRS 910, or may not transmit DMRS 910. In some examples, base station 105 may assign preamble blocks 905-f, 905-g, 905-h, and 905-i to UE 115-o. The resource blocks of these preamble blocks 905 may align with the resource blocks of DMRS 910-c and data 915-c. However, base station 105 may assign preamble blocks that do not span the entire frequency range 830. Thus, using the same number of symbols (e.g., two symbols) as UE 115-n, UE 115-o may transmit a set of sequences on four preamble blocks 905.

In some examples, the preamble block pool may include a set of TTIs 925 (e.g., three symbols), but base station 105 may assign preamble blocks 905 that are located only in a portion of the set of TTIs 925. For instance, base station 105 may assign preamble blocks 905-a, 905-b, and 905-c to UE 115-m, and may assign preamble blocks 905-d and 905-e to UE 115-n. Because preamble blocks 905-d and 905-e are located in the first two symbols of the preamble block pool, UE 115-n may have no preamble blocks to transmit in the third symbol of the preamble block pool. UE 115-n may transmit DMRS 910-b immediately following transmission of preamble block-e. That is, although UE 115-m may be transmitting preamble block 905-c during the third symbol of a preamble block pool, UE 115-n may have completed transmission of all preamble blocks 905, and may transmit DMRS 910-b or data 915-b without waiting for other UEs 115 to complete transmission of preamble blocks 905. Alternatively, UE 115-n may transmit DMRS 910-b after the set of TTIs 925 used for the preamble block pool, regardless of the number of symbol periods in which it has preamble blocks of the pool. Although the preamble block pool is illustrated as occurring prior to transmission of DMRS, the preamble block pool may overlap in time with DMRS for a given UE (e.g., using different frequency resources).

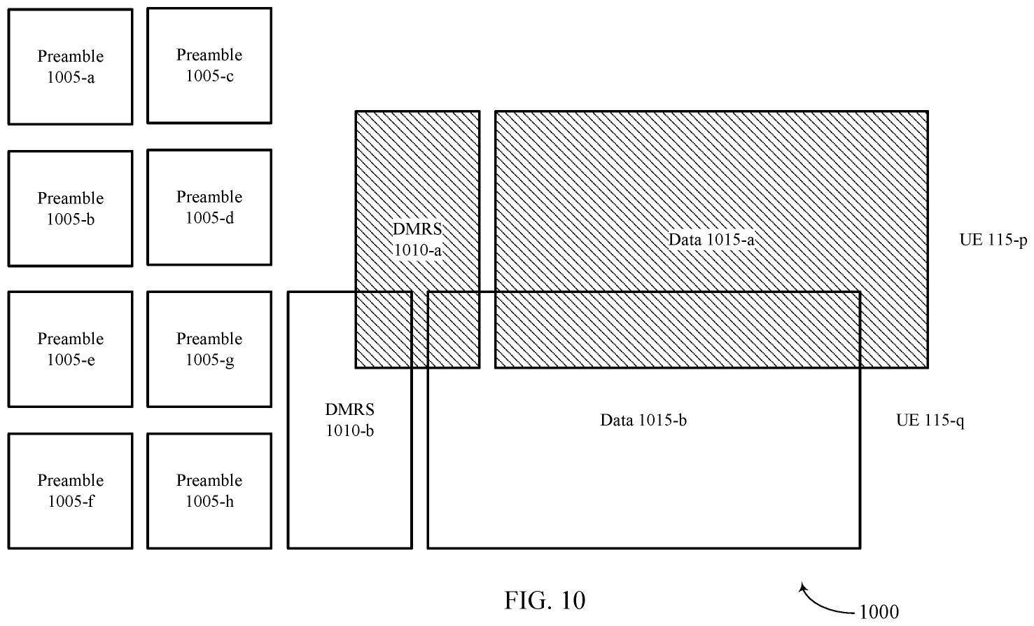

FIG. 10 illustrates an example of a subframe structure 1000 that supports block based preamble design for autonomous uplink transmissions in accordance with aspects of the present disclosure. In some examples, subframe structure 1000 may implement aspects of wireless communication system 100. Subframe structure 1000 may be used by one or more base stations 105 or UEs 115, which may be examples of the devices as described with reference to FIGS. 1 and 2.

In some examples, a base station 105 may assign respective sets of preamble blocks 1005 to a set of UEs 115, and some or all of the respective sets of preamble blocks may not align with sets of resource blocks used for data transmissions. The pool of preamble blocks may be common across UEs (e.g., UE 115-p, UE 115-q and other UEs 115), while UEs may have different resource allocations for data transmissions. In some cases, UEs with common resource block allocations for data transmissions may be allocated different sets of preamble blocks 1005 of the pool of preamble blocks. Base station 105 may assign preamble blocks 1005-a, 1005-b, 1005-c and 1005-d to UE 115-p, and may assign preamble blocks 1005-e, preamble block 1005-f, preamble block 1005-g, and preamble block 1005-h to UE 115-q.

In some cases, resource blocks for DMRS 1010 and data 1015 may depend on respective UEs 115. For instance, DMRS 1010-a and data 1015-a may have a resource block allocation dependent on UE 115-p. DMRS 1010-b and data 1015-b may have a resource block allocation dependent on UE 115-q. In such cases, the resource blocks for UE 115-p and UE 115-q may overlap partially or completely. For example, DMRS 1010-a and DMRS 1010-b may be located on the same resource blocks and may use the same time-frequency resources. Similarly, data 1015-a and data 1015-b may be located on the same resource blocks and use the same time-frequency resources. However, as described above, despite the overlapping resources of resource blocks for DMRS and data, preamble blocks 1005 may be assigned differently from a common pool of preamble blocks used for all or a subset of served UEs 115.

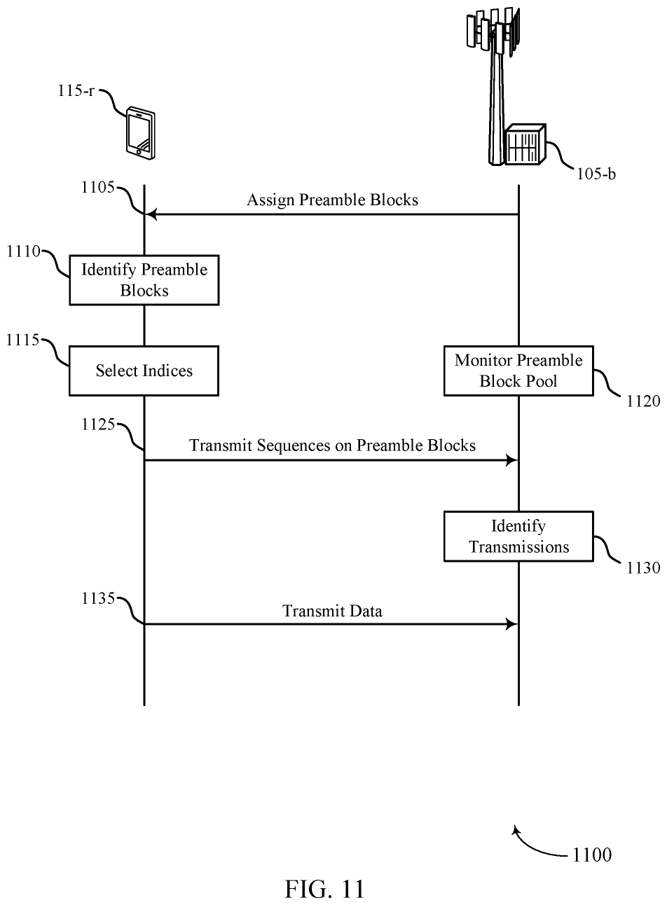

FIG. 11 illustrates an example of a process flow 1100 that supports block based preamble design for autonomous uplink transmissions in accordance with aspects of the present disclosure. In some examples, process flow 1100 may implement aspects of wireless communication system 100. Process flow 1100 may be implemented by one or more base station 105 or a UE 115, which may be examples of the devices as described with reference to FIGS. 1 and 2.

At 1105, base station 105-b may assign a set of preamble blocks for autonomous uplink transmission. Base station 105-b may assign the set of preamble blocks from a pool of preamble blocks.

At 1110, UE 115-r may identify the assigned set of preamble blocks for autonomous uplink transmission.

At 1115, UE 115-r may identify (select) an index for each preamble block of the set of preamble blocks. Each of the identified indices may correspond of one of a set of indexed sequences. The indexed sequences may be included in a pool of indexed sequences for transmitting on preamble blocks of the preamble block pool. In some examples, base station 105-b may also identify the set of indexed sequences for transmission over the respective sets of preamble blocks.

In some examples, UE 115-r may select the index for each preamble block of the set of preamble blocks by performing an encoding procedure. The encoding procedure may include one or more of encoding, demultiplexing, interleaving, or scrambling a bit stream representing a set of parameters or a set of substreams demultiplexed form the bit stream. The encoding procedure may result in the set of indices. Although parameters on which the indices are based may have small differences, the encoding procedure may a expand those difference to increase a hamming distance between indices. UE 115-r may apply the indices to the pool of indexed sequences, and may select sequences for transmission over the set of preamble blocks based on the indices.

At 1120, base station 105-b may monitor the pool of preamble blocks for composite sequences transmitted from the set of UEs over the respective sets of preamble blocks. For instance, when the base station 105-b identifies the set of indexed sequences for transmission over the respective sets of preamble blocks at 1115, the base station may recognize the set of sequences when transmitted from UE 115-r. In some examples each of the composite sequences may include one or more indexed sequences of the set of indexed sequences. Base station 105-b may monitor for a combination of the recognizable sequences transmitted from UE 115-r.

At 1125, UE 115-r may transmit one or more sequences over the set of preamble blocks. For instance, UE 115-r may transmit the one or more sequences as part of a two-step RACH procedure or four-step RACH procedure. The sequences may correspond to the selected indices for the set of preamble blocks. The sequences transmitted over the set of preamble blocks may be distinct from other sequences transmitted over preamble blocks from other UEs 115 based on the indices selected at 1115.

At 1130, base station 105-b may identify one or more transmissions based on sequences transmitted on preamble blocks at 1125. Base station 105-b may identify the transmissions based on detecting one or more corresponding composite sequences from the monitoring at 1120. Base station 105-b may receive the sequences transmitted on preamble blocks, and may further receive a DMRS transmission from UE 115-r, or a data transmission from UE 115-r at 1135, or both.

At 1135, UE 115-r may transmit data to base station 105-b. UE 115-r may transmit the data during symbols or a TTI that is associated with the set of preamble blocks. For instance, the symbols or TTI may be subsequent to the set of preamble blocks, simultaneous to the set of preamble blocks, or the like. UE 115-r may also transmit a DMRS to base station 105-b. UE 115-r may transmit the DMRS after transmitting the sequences over preamble blocks at 1125, and may transmit the data after transmitting the DMRS.

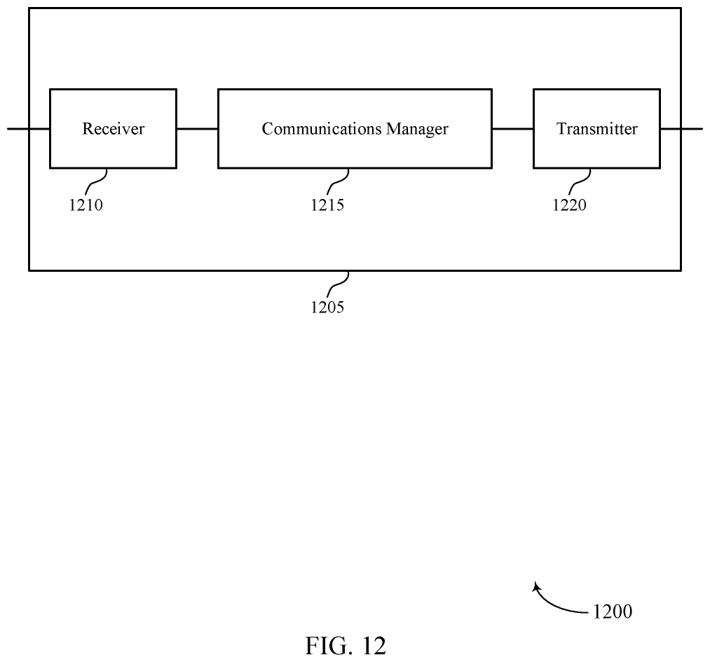

FIG. 12 shows a block diagram 1200 of a device 1205 that supports block based preamble design for autonomous uplink transmissions in accordance with aspects of the present disclosure. The device 1205 may be an example of aspects of a UE 115 as described herein. The device 1205 may include a receiver 1210, a communications manager 1215, and a transmitter 1220. The device 1205 may also include a processor. Each of these components may be in communication with one another (e.g., via one or more buses). In some examples, communications manager 1215 may be implemented by a modem. Communications manager 1215 may communicate with transmitter 1220 via a first interface. Communications manager 1215 may output signals for transmission via the first interface. Communications manager 1215 may interface with receiver 1210 via a second interface. Communications manager 1215 obtain signals (e.g., transmitted from a base station 105) via the second interface. In some examples, the modem may implement, via the first interface and the second interface, the techniques and methods described herein. Such techniques may result in improved efficiency, increased flexibility (e.g., scalability of number of served UEs for autonomous uplink transmissions), and overall system efficiency.

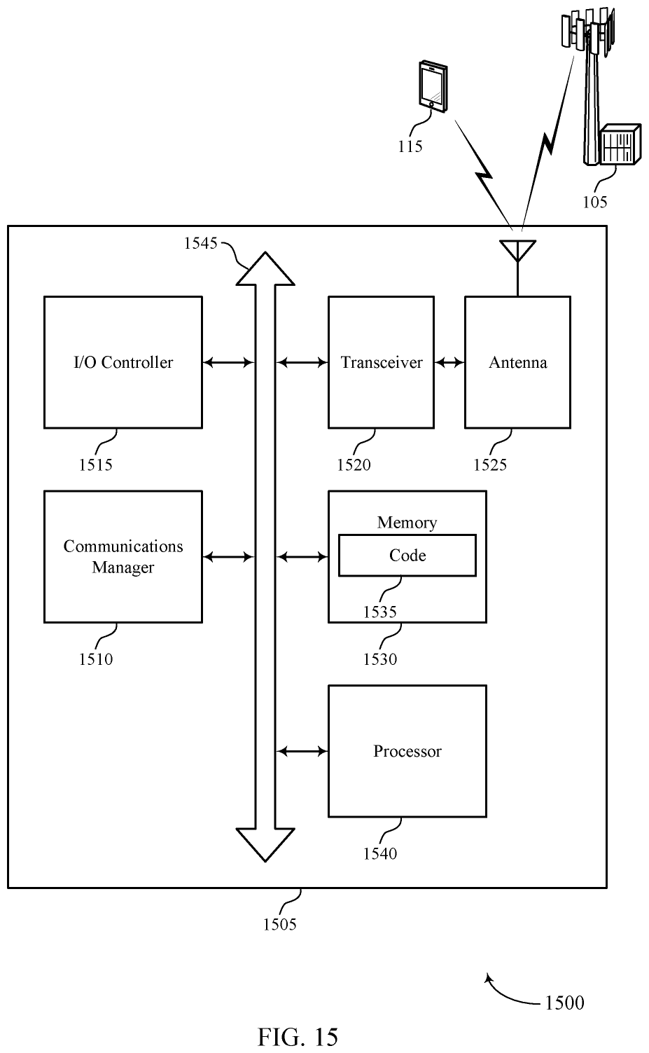

The receiver 1210 may receive information such as packets, user data, or control information associated with various information channels (e.g., control channels, data channels, and information related to block based preamble design for autonomous uplink transmissions, etc.). Information may be passed on to other components of the device 1205. The receiver 1210 may be an example of aspects of the transceiver 1520 described with reference to FIG. 15. The receiver 1210 may utilize a single antenna or a set of antennas.

The communications manager 1215 may identify a set of preamble blocks for autonomous uplink transmissions, the set of preamble blocks being assigned by a base station from a pool of preamble blocks, transmit one or more of the indexed sequences over the set of preamble blocks, the one or more of the indexed sequences corresponding to the identified indices for the set of preamble blocks, identify an index for each preamble block of the set of preamble blocks, each of the identified indices corresponding to one of a set of indexed sequences, and transmit a data transmission during a TTI associated with the set of preamble blocks. The communications manager 1215 may be an example of aspects of the communications manager 1510 described herein.

The communications manager 1215, or its sub-components, may be implemented in hardware, code (e.g., software or firmware) executed by a processor, or any combination thereof. If implemented in code executed by a processor, the functions of the communications manager 1215, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 1215, or its sub-components, may be physically located at various positions, including being distributed such that portions of functions are implemented at different physical locations by one or more physical components. In some examples, the communications manager 1215, or its sub-components, may be a separate and distinct component in accordance with various aspects of the present disclosure. In some examples, the communications manager 1215, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1220 may transmit signals generated by other components of the device 1205. In some examples, the transmitter 1220 may be collocated with a receiver 1210 in a transceiver module. For example, the transmitter 1220 may be an example of aspects of the transceiver 1520 described with reference to FIG. 15. The transmitter 1220 may utilize a single antenna or a set of antennas.

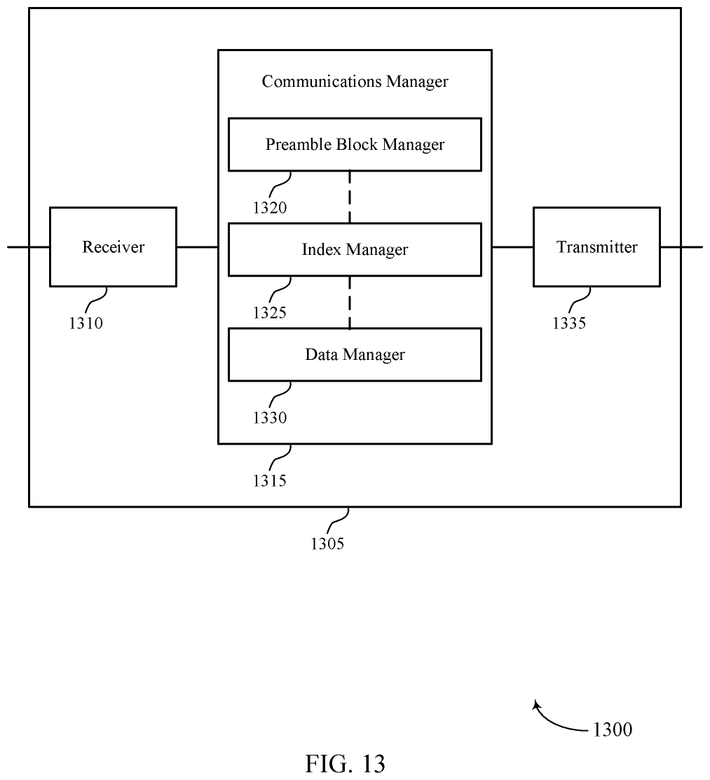

FIG. 13 shows a block diagram 1300 of a device 1305 that supports block based preamble design for autonomous uplink transmissions in accordance with aspects of the present disclosure. The device 1305 may be an example of aspects of a device 1205 or a UE 115 as described herein. The device 1305 may include a receiver 1310, a communications manager 1315, and a transmitter 1335. The device 1305 may also include a processor. Each of these components may be in communication with one another (e.g., via one or more buses).

The receiver 1310 may receive information such as packets, user data, or control information associated with various information channels (e.g., control channels, data channels, and information related to block based preamble design for autonomous uplink transmissions, etc.). Information may be passed on to other components of the device 1305. The receiver 1310 may be an example of aspects of the transceiver 1520 described with reference to FIG. 15. The receiver 1310 may utilize a single antenna or a set of antennas.

The communications manager 1315 may be an example of aspects of the communications manager 1215 as described herein. The communications manager 1315 may include a preamble block manager 1320, an index manager 1325, and a data manager 1330. The communications manager 1315 may be an example of aspects of the communications manager 1510 described herein.

The preamble block manager 1320 may identify a set of preamble blocks for autonomous uplink transmissions, the set of preamble blocks being assigned by a base station from a pool of preamble blocks and transmit one or more of the indexed sequences over the set of preamble blocks, the one or more of the indexed sequences corresponding to the identified indices for the set of preamble blocks.

The index manager 1325 may identify an index for each preamble block of the set of preamble blocks, each of the identified indices corresponding to one of a set of indexed sequences.

The data manager 1330 may transmit a data transmission during a TTI associated with the set of preamble blocks.

The transmitter 1335 may transmit signals generated by other components of the device 1305. In some examples, the transmitter 1335 may be collocated with a receiver 1310 in a transceiver module. For example, the transmitter 1335 may be an example of aspects of the transceiver 1520 described with reference to FIG. 15. The transmitter 1335 may utilize a single antenna or a set of antennas.

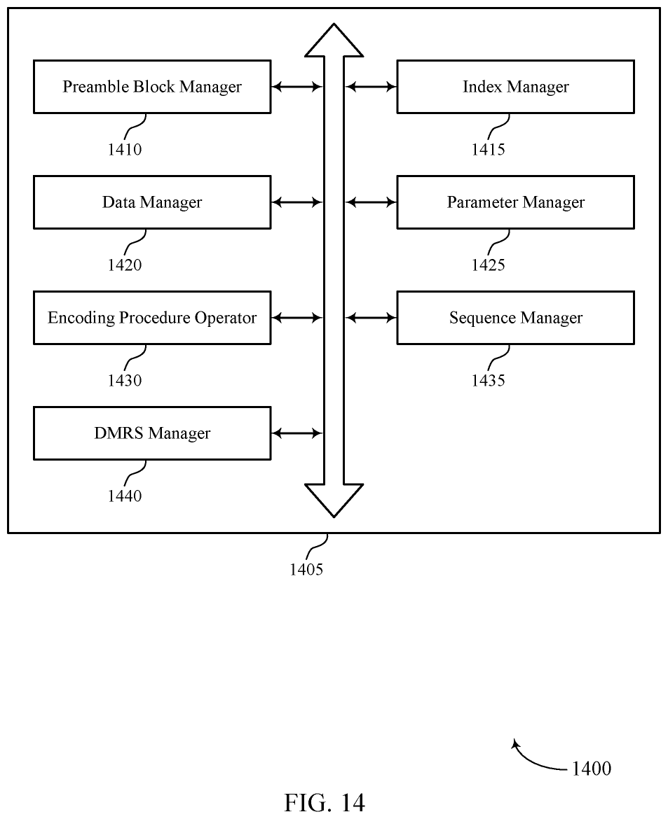

FIG. 14 shows a block diagram 1400 of a communications manager 1405 that supports block based preamble design for autonomous uplink transmissions in accordance with aspects of the present disclosure. The communications manager 1405 may be an example of aspects of a communications manager 1215, a communications manager 1315, or a communications manager 1510 described herein. The communications manager 1405 may include a preamble block manager 1410, an index manager 1415, a data manager 1420, a parameter manager 1425, an encoding procedure operator 1430, a sequence manager 1435, and a DMRS manager 1440. Each of these modules may communicate, directly or indirectly, with one another (e.g., via one or more buses).

The preamble block manager 1410 may identify a set of preamble blocks for autonomous uplink transmissions, the set of preamble blocks being assigned by a base station from a pool of preamble blocks.

In some examples, the preamble block manager 1410 may transmit one or more of the indexed sequences over the set of preamble blocks, the one or more of the indexed sequences corresponding to the identified indices for the set of preamble blocks. In some examples, the preamble block manager 1410 may map the set of preamble blocks to a set of physical resources according to a mapping function. In some examples, the preamble block manager 1410 may map the preamble blocks to consecutive time-frequency resources, interleaved time-frequency resources, or comb based interleaved time-frequency resources.

In some examples, the preamble block manager 1410 may receive signaling from the base station assigning the set of preamble blocks for autonomous uplink transmissions via RRC signaling, DCI signaling, system information (SI) signaling, or a combination thereof. In some cases, each preamble block of the set of preamble blocks includes a set of time-frequency resources. In some cases, the resources of each preamble block of the set of preamble blocks is bounded by a set of rules.

The index manager 1415 may identify an index for each preamble block of the set of preamble blocks, each of the identified indices corresponding to one of a set of indexed sequences. In some examples, the index manager 1415 may map each of the series of indices to the corresponding one of the set of indexed sequences to obtain the one or more of the indexed sequences. In some examples, the index manager 1415 may map each encoded sub stream of the set of encoded sub streams to a respective one of the set of indexed sequences. In some examples, the index manager 1415 may map each encoded substream of the set of encoded sub streams to a respective one of the set of indexed sequences.

The data manager 1420 may transmit a data transmission during a TTI associated with the set of preamble blocks.

The parameter manager 1425 may identify a set of parameters, the set of parameters including a cell identifier, a UE identifier, a timing index, a parameter received via DCI signaling or RRC signaling, or a combination thereof. In some examples, the parameter manager 1425 may identify a set of parameters, the set of parameters including a cell identifier, a UE identifier, a parameter received via a DCI, a parameter received via an RRC signal, or a combination thereof.

The encoding procedure operator 1430 may perform an encoding procedure on the set of parameters to obtain a series of indices. In some examples, the encoding procedure operator 1430 may represent the set of parameters as a bit stream. In some examples, the encoding procedure operator 1430 may divide the bit stream into a set of sub streams.

In some examples, the encoding procedure operator 1430 may perform a stream encoding operation on the set of substreams to obtain a set of encoded substreams, a number of encoded substreams in the set of encoded substreams corresponding to a number of preamble blocks in the set of preamble blocks. In some examples, the encoding procedure operator 1430 may map each of the set of substreams to one of a first set of numbers, the first set of numbers having a first dimension.

In some examples, the encoding procedure operator 1430 may encode the mapped set of sub streams according to a generator matrix to obtain the set of encoded sub streams, where a dimension of the generator matrix corresponds to the number of preamble blocks. In some examples, the encoding procedure operator 1430 may represent the set of parameters as bit stream. In some examples, the encoding procedure operator 1430 may encode the bit stream to obtain an encoded bit stream.

In some examples, the encoding procedure operator 1430 may divide the encoded bit stream into a set of encoded substreams, a number of encoded substreams in the set of encoded substreams corresponding to a number of preamble blocks in the set of preamble blocks. In some examples, the encoding procedure operator 1430 may interleave and scrambling the bit stream prior to the encoding.

In some examples, the encoding procedure operator 1430 may interleave and scrambling the encoded bit stream prior to the dividing. The sequence manager 1435 may receive signaling, from the base station, configuring the set of indexed sequences via RRC signaling, DCI signaling, system information (SI) signaling, or a combination thereof In some cases, each indexed sequence of the set of indexed sequences is a Zadoff-Chu sequence with a respective root and cyclic shift, a gold sequence with a respective initial register status, a Galois sequence, an orthogonal basis sequence, or any combination thereof.

The DMRS manager 1440 may transmit a demodulation reference signal (DMRS) after transmitting the one or more of the indexed sequences over the set of preamble blocks and prior to transmitting the data transmission. In some examples, the DMRS manager 1440 may transmit the DMRS based on the set of parameters.

FIG. 15 shows a diagram of a system 1500 including a device 1505 that supports block based preamble design for autonomous uplink transmissions in accordance with aspects of the present disclosure. The device 1505 may be an example of or include the components of device 1205, device 1305, or a UE 115 as described herein. The device 1505 may include components for bi-directional voice and data communications including components for transmitting and receiving communications, including a communications manager 1510, an I/O controller 1515, a transceiver 1520, an antenna 1525, memory 1530, and a processor 1540. These components may be in electronic communication via one or more buses (e.g., bus 1545).

The communications manager 1510 may identify a set of preamble blocks for autonomous uplink transmissions, the set of preamble blocks being assigned by a base station from a pool of preamble blocks, transmit one or more of the indexed sequences over the set of preamble blocks, the one or more of the indexed sequences corresponding to the identified indices for the set of preamble blocks, identify an index for each preamble block of the set of preamble blocks, each of the identified indices corresponding to one of a set of indexed sequences, and transmit a data transmission during a TTI associated with the set of preamble blocks.

The I/O controller 1515 may manage input and output signals for the device 1505. The I/O controller 1515 may also manage peripherals not integrated into the device 1505. In some cases, the I/O controller 1515 may represent a physical connection or port to an external peripheral. In some cases, the I/O controller 1515 may utilize an operating system such as iOS®, ANDROID®, MS-DOS®, MS-WINDOWS®, OS/2®, UNIX®, LINUX®, or another known operating system. In other cases, the I/O controller 1515 may represent or interact with a modem, a keyboard, a mouse, a touchscreen, or a similar device. In some cases, the I/O controller 1515 may be implemented as part of a processor. In some cases, a user may interact with the device 1505 via the I/O controller 1515 or via hardware components controlled by the I/O controller 1515.

The transceiver 1520 may communicate bi-directionally, via one or more antennas, wired, or wireless links as described above. For example, the transceiver 1520 may represent a wireless transceiver and may communicate bi-directionally with another wireless transceiver. The transceiver 1520 may also include a modem to modulate the packets and provide the modulated packets to the antennas for transmission, and to demodulate packets received from the antennas.

In some cases, the wireless device may include a single antenna 1525. However, in some cases the device may have more than one antenna 1525, which may be capable of concurrently transmitting or receiving multiple wireless transmissions.

The memory 1530 may include random-access memory (RAM) and read-only memory (ROM). The memory 1530 may store computer-readable, computer-executable code 1535 including instructions that, when executed, cause the processor to perform various functions described herein. In some cases, the memory 1530 may contain, among other things, a basic input/output system (BIOS) which may control basic hardware or software operation such as the interaction with peripheral components or devices.

The processor 1540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting block based preamble design for autonomous uplink transmissions).

The code 1535 may include instructions to implement aspects of the present disclosure, including instructions to support wireless communications. The code 1535 may be stored in a non-transitory computer-readable medium such as system memory or other type of memory. In some cases, the code 1535 may not be directly executable by the processor 1540 but may cause a computer (e.g., when compiled and executed) to perform functions described herein.

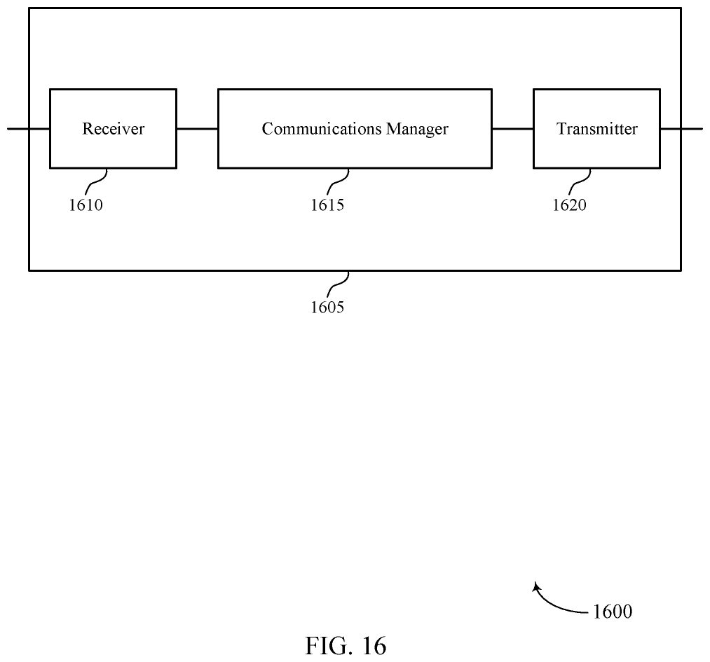

FIG. 16 shows a block diagram 1600 of a device 1605 that supports block based preamble design for autonomous uplink transmissions in accordance with aspects of the present disclosure. The device 1605 may be an example of aspects of a base station 105 as described herein. The device 1605 may include a receiver 1610, a communications manager 1615, and a transmitter 1620. The device 1605 may also include a processor. Each of these components may be in communication with one another (e.g., via one or more buses). In some examples, communications manager 1615 may be implemented by a modem. Communications manager 1615 may communicate with transmitter 1620 via a first interface. Communications manager 1615 may output signals for transmission via the first interface. Communications manager 1615 may interface with receiver 1610 via a second interface. Communications manager 1615 obtain signals (e.g., transmitted from a base station 105) via the second interface. In some examples, the modem may implement, via the first interface and the second interface, the techniques and methods described herein. Such techniques may result in improved efficiency, increased flexibility and increased computational resources, and overall system efficiency.

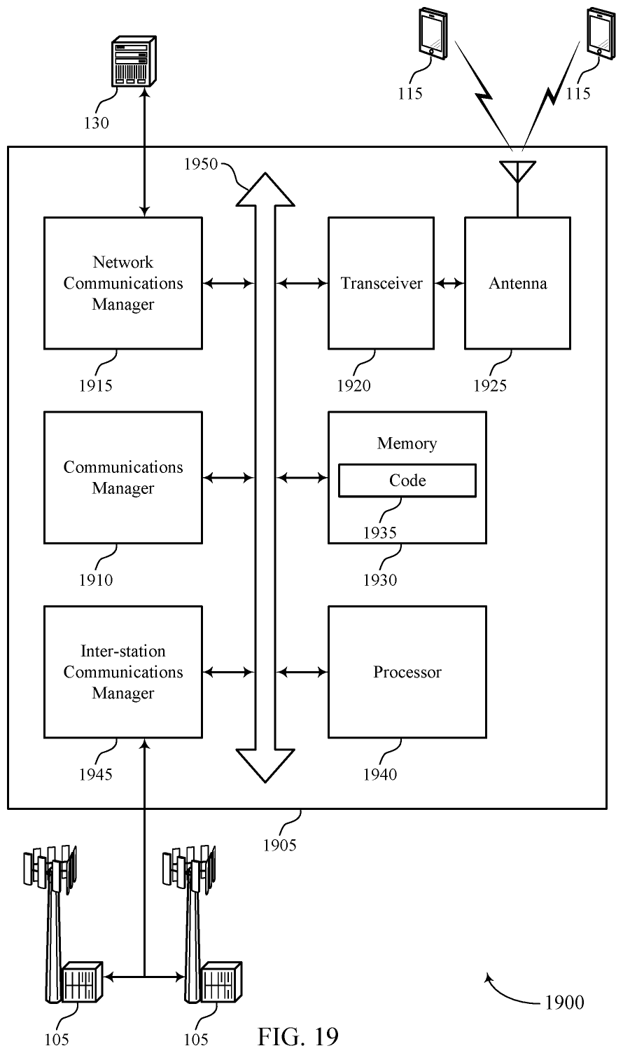

The receiver 1610 may receive information such as packets, user data, or control information associated with various information channels (e.g., control channels, data channels, and information related to block based preamble design for autonomous uplink transmissions, etc.). Information may be passed on to other components of the device 1605. The receiver 1610 may be an example of aspects of the transceiver 1920 described with reference to FIG. 19. The receiver 1610 may utilize a single antenna or a set of antennas.

The communications manager 1615 may assign respective sets of preamble blocks to a set of user equipments (UEs) for autonomous uplink transmissions, each of the respective sets of preamble blocks assigned from a pool of preamble blocks, identify a set of indexed sequences for transmission over the respective sets of preamble blocks, identify one or more transmissions from one or more of the set of UEs based on detecting one or more corresponding composite sequences from the monitoring, receive the one or more transmissions, and monitor the pool of preamble blocks for composite sequences transmitted from the set of UEs over the respective sets of preamble blocks, each of the composite sequences including one or more indexed sequences of the set of indexed sequences. The communications manager 1615 may be an example of aspects of the communications manager 1910 described herein.

The communications manager 1615, or its sub-components, may be implemented in hardware, code (e.g., software or firmware) executed by a processor, or any combination thereof. If implemented in code executed by a processor, the functions of the communications manager 1615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1615, or its sub-components, may be physically located at various positions, including being distributed such that portions of functions are implemented at different physical locations by one or more physical components. In some examples, the communications manager 1615, or its sub-components, may be a separate and distinct component in accordance with various aspects of the present disclosure. In some examples, the communications manager 1615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1620 may transmit signals generated by other components of the device 1605. In some examples, the transmitter 1620 may be collocated with a receiver 1610 in a transceiver module. For example, the transmitter 1620 may be an example of aspects of the transceiver 1920 described with reference to FIG. 19. The transmitter 1620 may utilize a single antenna or a set of antennas.

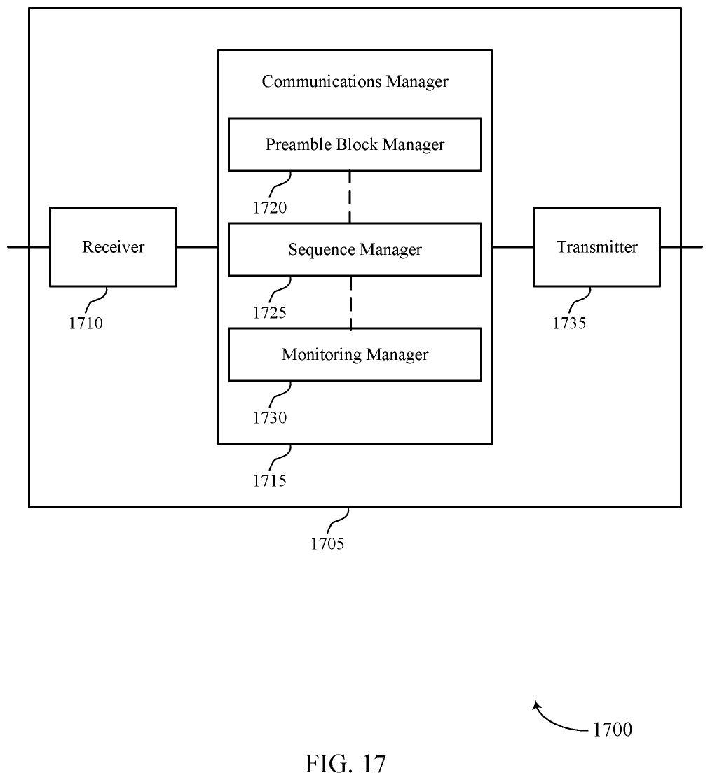

FIG. 17 shows a block diagram 1700 of a device 1705 that supports block based preamble design for autonomous uplink transmissions in accordance with aspects of the present disclosure. The device 1705 may be an example of aspects of a device 1605 or a base station 105 as described herein. The device 1705 may include a receiver 1710, a communications manager 1715, and a transmitter 1735. The device 1705 may also include a processor. Each of these components may be in communication with one another (e.g., via one or more buses).

The receiver 1710 may receive information such as packets, user data, or control information associated with various information channels (e.g., control channels, data channels, and information related to block based preamble design for autonomous uplink transmissions, etc.). Information may be passed on to other components of the device 1705. The receiver 1710 may be an example of aspects of the transceiver 1920 described with reference to FIG. 19. The receiver 1710 may utilize a single antenna or a set of antennas.

The communications manager 1715 may be an example of aspects of the communications manager 1615 as described herein. The communications manager 1715 may include a preamble block manager 1720, a sequence manager 1725, and a monitoring manager 1730. The communications manager 1715 may be an example of aspects of the communications manager 1910 described herein.

The preamble block manager 1720 may assign respective sets of preamble blocks to a set of user equipments (UEs) for autonomous uplink transmissions, each of the respective sets of preamble blocks assigned from a pool of preamble blocks.

The sequence manager 1725 may identify a set of indexed sequences for transmission over the respective sets of preamble blocks, identify one or more transmissions from one or more of the set of UEs based on detecting one or more corresponding composite sequences from the monitoring, and receive the one or more transmissions.

The monitoring manager 1730 may monitor the pool of preamble blocks for composite sequences transmitted from the set of UEs over the respective sets of preamble blocks, each of the composite sequences including one or more indexed sequences of the set of indexed sequences.

The transmitter 1735 may transmit signals generated by other components of the device 1705. In some examples, the transmitter 1735 may be collocated with a receiver 1710 in a transceiver module. For example, the transmitter 1735 may be an example of aspects of the transceiver 1920 described with reference to FIG. 19. The transmitter 1735 may utilize a single antenna or a set of antennas.

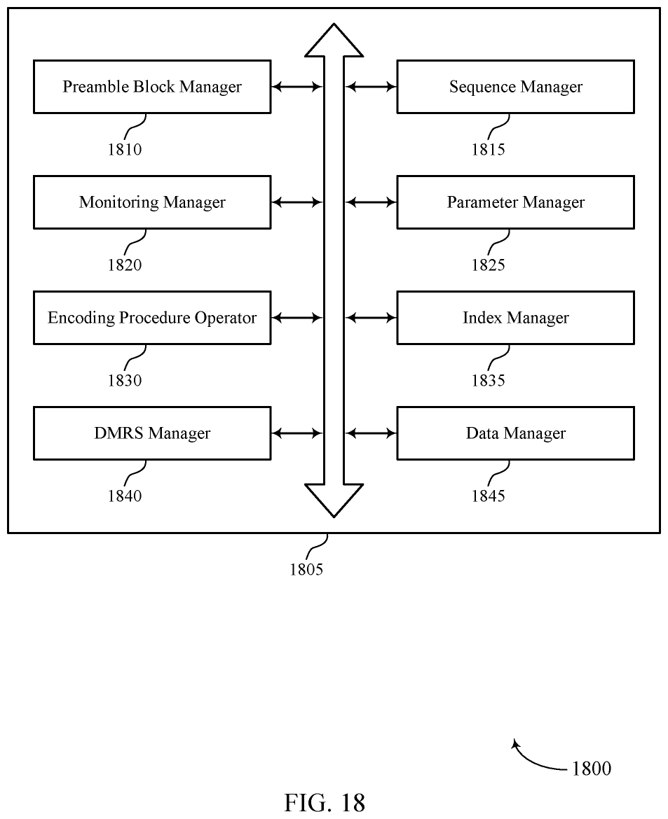

FIG. 18 shows a block diagram 1800 of a communications manager 1805 that supports block based preamble design for autonomous uplink transmissions in accordance with aspects of the present disclosure. The communications manager 1805 may be an example of aspects of a communications manager 1615, a communications manager 1715, or a communications manager 1910 described herein. The communications manager 1805 may include a preamble block manager 1810, a sequence manager 1815, a monitoring manager 1820, a parameter manager 1825, an encoding procedure operator 1830, an index manager 1835, a DMRS manager 1840, and a data manager 1845. Each of these modules may communicate, directly or indirectly, with one another (e.g., via one or more buses).

The preamble block manager 1810 may assign respective sets of preamble blocks to a set of user equipments (UEs) for autonomous uplink transmissions, each of the respective sets of preamble blocks assigned from a pool of preamble blocks. In some examples, the preamble block manager 1810 may map the preamble blocks to consecutive time-frequency resources, interleaved time-frequency resources, or comb based interleaved time-frequency resources. In some cases, each preamble block of the respective sets of preamble blocks includes a set of time-frequency resources.

In some cases, each preamble block of the respective sets of preamble blocks are bounded by a set of rules.

The sequence manager 1815 may identify a set of indexed sequences for transmission over the respective sets of preamble blocks. In some examples, the sequence manager 1815 may identify one or more transmissions from one or more of the set of UEs based on detecting one or more corresponding composite sequences from the monitoring. In some examples, the sequence manager 1815 may receive the one or more transmissions.

In some examples, the sequence manager 1815 may receive a composite sequence of the one or more corresponding composite sequences from a UE of the set of UEs. In some examples, the sequence manager 1815 may transmit signaling, to the set of UEs, the signaling configuring the set of indexed sequences via RRC signaling, DCI signaling, system information (SI) signaling, or a combination thereof. In some cases, each indexed sequences of the set of indexed sequences is a Zadoff-Chu sequence with a respective root and cyclic shift, a gold sequence with a respective initial register status, a Galois sequence, an orthogonal basis sequence, or any combination thereof.

The monitoring manager 1820 may monitor the pool of preamble blocks for composite sequences transmitted from the set of UEs over the respective sets of preamble blocks, each of the composite sequences including one or more indexed sequences of the set of indexed sequences. In some examples, the monitoring manager 1820 may monitor the pool of preamble blocks for the composite sequences based on the mapping. In some examples, the monitoring manager 1820 may monitor the pool of preamble blocks for the composite sequences based on the mapped set of encoded sub streams.

The parameter manager 1825 may identify a set of parameters associated with a UE of the set of UEs, the set of parameters including a cell identifier, a UE identifier, a timing index, a parameter transmitted to the each of the set of UEs via DCI signaling or RRC signaling, or a combination thereof. In some examples, the parameter manager 1825 may identify a set of parameters, the set of parameters including a cell identifier, a UE identifier, a parameter transmitted to the each of the set of UEs via DCI signaling or resource control (RRC) signaling, or a combination thereof.

The encoding procedure operator 1830 may perform an encoding procedure on the set of parameters to obtain a series of indices. In some examples, the encoding procedure operator 1830 may represent the set of parameters as a bit stream. In some examples, the encoding procedure operator 1830 may divide the bit stream into a set of substreams. In some examples, the encoding procedure operator 1830 may perform a stream encoding operation on the set of substreams to obtain a set of encoded substreams, a number of encoded substreams in the set of encoded substreams corresponding to a number of preamble blocks in the respective set of preamble blocks.

In some examples, the encoding procedure operator 1830 may map each of the set of substreams to one of a first set of numbers, the first set of numbers having a first dimension. In some examples, the encoding procedure operator 1830 may encode the mapped set of sub streams according to a generator matrix to obtain the set of encoded sub streams, where a dimension of the generator matrix corresponds to the number of preamble blocks. In some examples, the encoding procedure operator 1830 may represent the set of parameters as bit stream. In some examples, the encoding procedure operator 1830 may encode the bit stream to obtain an encoded bit stream.

In some examples, the encoding procedure operator 1830 may divide the encoded bit stream into a set of encoded substreams, a number of encoded substreams in the set of encoded substreams corresponding to a number of preamble blocks in the respective set of preamble blocks. In some examples, the encoding procedure operator 1830 may interleave and scrambling the bit stream prior to the encoding. In some examples, the encoding procedure operator 1830 may interleave and scrambling the encoded bit stream prior to the dividing.

The index manager 1835 may map each of the series of indices to the corresponding one of the set of indexed sequences to obtain the one or more indexed sequences.

In some examples, the index manager 1835 may map each encoded substream of the set of encoded sub streams to a respective one of the set of indexed sequences.

In some examples, the index manager 1835 may map each encoded substream of the set of encoded sub streams to a respective one of the set of indexed sequences.

The DMRS manager 1840 may receive a demodulation reference signal (DMRS) after receiving the composite sequence. In some examples, the DMRS manager 1840 may receive the DMRS based on the set of parameters.

The data manager 1845 may receive a data transmission after receiving the DMRS.

FIG. 19 shows a diagram of a system 1900 including a device 1905 that supports block based preamble design for autonomous uplink transmissions in accordance with aspects of the present disclosure. The device 1905 may be an example of or include the components of device 1605, device 1705, or a base station 105 as described herein. The device 1905 may include components for bi-directional voice and data communications including components for transmitting and receiving communications, including a communications manager 1910, a network communications manager 1915, a transceiver 1920, an antenna 1925, memory 1930, a processor 1940, and an inter-station communications manager 1945. These components may be in electronic communication via one or more buses (e.g., bus 1950).

The communications manager 1910 may assign respective sets of preamble blocks to a set of user equipments (UEs) for autonomous uplink transmissions, each of the respective sets of preamble blocks assigned from a pool of preamble blocks, identify a set of indexed sequences for transmission over the respective sets of preamble blocks, identify one or more transmissions from one or more of the set of UEs based on detecting one or more corresponding composite sequences from the monitoring, receive the one or more transmissions, and monitor the pool of preamble blocks for composite sequences transmitted from the set of UEs over the respective sets of preamble blocks, each of the composite sequences including one or more indexed sequences of the set of indexed sequences.

The network communications manager 1915 may manage communications with the core network (e.g., via one or more wired backhaul links). For example, the network communications manager 1915 may manage the transfer of data communications for client devices, such as one or more UEs 115.

The transceiver 1920 may communicate bi-directionally, via one or more antennas, wired, or wireless links as described above. For example, the transceiver 1920 may represent a wireless transceiver and may communicate bi-directionally with another wireless transceiver. The transceiver 1920 may also include a modem to modulate the packets and provide the modulated packets to the antennas for transmission, and to demodulate packets received from the antennas.

In some cases, the wireless device may include a single antenna 1925. However, in some cases the device may have more than one antenna 1925, which may be capable of concurrently transmitting or receiving multiple wireless transmissions.

The memory 1930 may include RAM, ROM, or a combination thereof. The memory 1930 may store computer-readable code 1935 including instructions that, when executed by a processor (e.g., the processor 1940) cause the device to perform various functions described herein. In some cases, the memory 1930 may contain, among other things, a BIOS which may control basic hardware or software operation such as the interaction with peripheral components or devices.

The processor 1940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1940 may be configured to operate a memory array using a memory controller. In some cases, a memory controller may be integrated into processor 1940. The processor 1940 may be configured to execute computer-readable instructions stored in a memory (e.g., the memory 1930) to cause the device to perform various functions (e.g., functions or tasks supporting block based preamble design for autonomous uplink transmissions).

The inter-station communications manager 1945 may manage communications with other base station 105, and may include a controller or scheduler for controlling communications with UEs 115 in cooperation with other base stations 105. For example, the inter-station communications manager 1945 may coordinate scheduling for transmissions to UEs 115 for various interference mitigation techniques such as beamforming or joint transmission. In some examples, the inter-station communications manager 1945 may provide an X2 interface within an LTE/LTE-A wireless communication network technology to provide communication between base stations 105.

The code 1935 may include instructions to implement aspects of the present disclosure, including instructions to support wireless communications. The code 1935 may be stored in a non-transitory computer-readable medium such as system memory or other type of memory. In some cases, the code 1935 may not be directly executable by the processor 1940 but may cause a computer (e.g., when compiled and executed) to perform functions described herein.

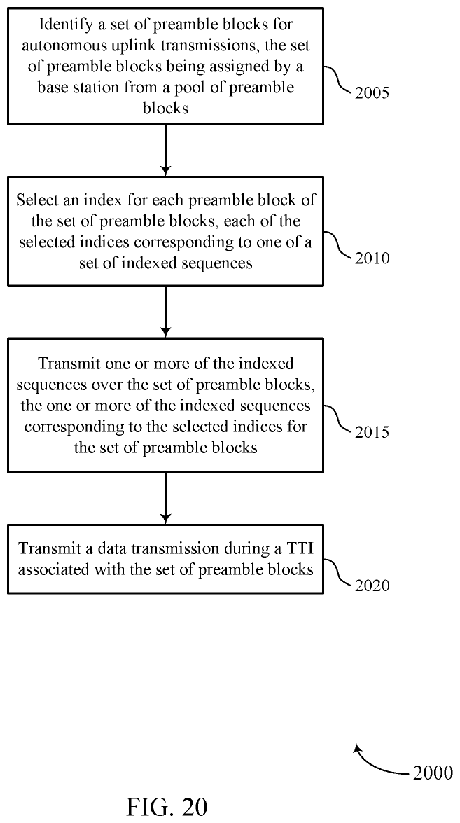

FIG. 20 shows a flowchart illustrating a method 2000 that supports block based preamble design for autonomous uplink transmissions in accordance with aspects of the present disclosure. The operations of method 2000 may be implemented by a UE 115 or its components as described herein. For example, the operations of method 2000 may be performed by a communications manager as described with reference to FIGS. 12 through 15. In some examples, a UE may execute a set of instructions to control the functional elements of the UE to perform the functions described below. Additionally, or alternatively, a UE may perform aspects of the functions described below using special-purpose hardware.

At 2005, the UE may identify a set of preamble blocks for autonomous uplink transmissions, the set of preamble blocks being assigned by a base station from a pool of preamble blocks. The operations of 2005 may be performed according to the methods described herein. In some examples, aspects of the operations of 2005 may be performed by a preamble block manager as described with reference to FIGS. 12 through 15.

At 2010, the UE may identify (e.g., select) an index for each preamble block of the set of preamble blocks, each of the identified indices corresponding to one of a set of indexed sequences. The operations of 2010 may be performed according to the methods described herein. In some examples, aspects of the operations of 2010 may be performed by an index manager as described with reference to FIGS. 12 through 15.

At 2015, the UE may transmit one or more of the indexed sequences over the set of preamble blocks, the one or more of the indexed sequences corresponding to the identified indices for the set of preamble blocks. The operations of 2015 may be performed according to the methods described herein. In some examples, aspects of the operations of 2015 may be performed by a preamble block manager as described with reference to FIGS. 12 through 15.

At 2020, the UE may transmit a data transmission during a TTI associated with the set of preamble blocks. The operations of 2020 may be performed according to the methods described herein. In some examples, aspects of the operations of 2020 may be performed by a data manager as described with reference to FIGS. 12 through 15.

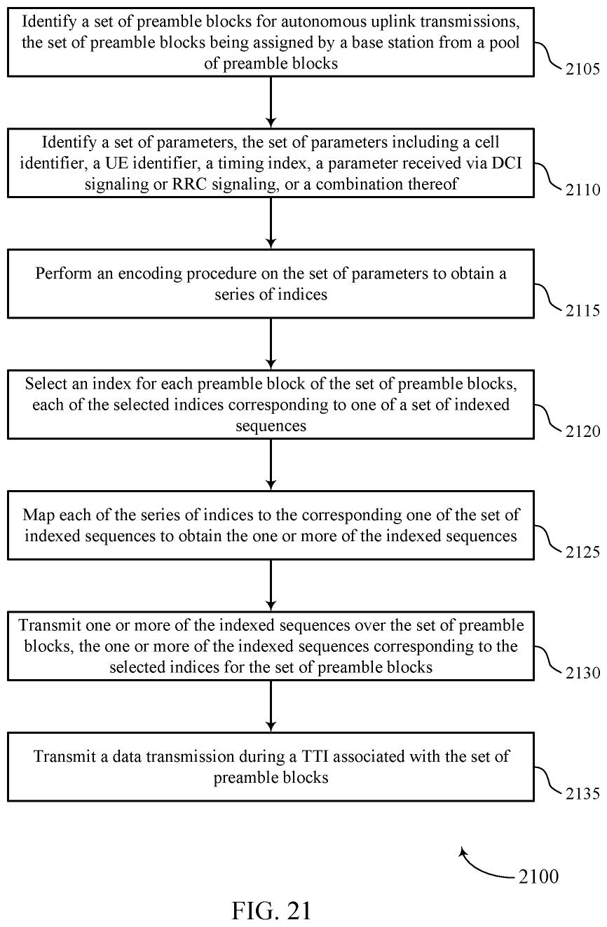

FIG. 21 shows a flowchart illustrating a method 2100 that supports block based preamble design for autonomous uplink transmissions in accordance with aspects of the present disclosure. The operations of method 2100 may be implemented by a UE 115 or its components as described herein. For example, the operations of method 2100 may be performed by a communications manager as described with reference to FIGS. 12 through 15. In some examples, a UE may execute a set of instructions to control the functional elements of the UE to perform the functions described below. Additionally, or alternatively, a UE may perform aspects of the functions described below using special-purpose hardware.

At 2105, the UE may identify a set of preamble blocks for autonomous uplink transmissions, the set of preamble blocks being assigned by a base station from a pool of preamble blocks. The operations of 2105 may be performed according to the methods described herein. In some examples, aspects of the operations of 2105 may be performed by a preamble block manager as described with reference to FIGS. 12 through 15.

At 2110, the UE may identify a set of parameters, the set of parameters including a cell identifier, a UE identifier, a timing index, a parameter received via DCI signaling or RRC signaling, or a combination thereof. The operations of 2110 may be performed according to the methods described herein. In some examples, aspects of the operations of 2110 may be performed by a parameter manager as described with reference to FIGS. 12 through 15.

At 2115, the UE may perform an encoding procedure on the set of parameters to obtain a series of indices. The operations of 2115 may be performed according to the methods described herein. In some examples, aspects of the operations of 2115 may be performed by an encoding procedure operator as described with reference to FIGS. 12 through 15.

At 2120, the UE may identify (e.g., select) an index for each preamble block of the set of preamble blocks, each of the identified indices corresponding to one of a set of indexed sequences. The operations of 2120 may be performed according to the methods described herein. In some examples, aspects of the operations of 2120 may be performed by an index manager as described with reference to FIGS. 12 through 15.

At 2125, the UE may map each of the series of indices to the corresponding one of the set of indexed sequences to obtain the one or more of the indexed sequences. The operations of 2125 may be performed according to the methods described herein. In some examples, aspects of the operations of 2125 may be performed by an index manager as described with reference to FIGS. 12 through 15.

At 2130, the UE may transmit one or more of the indexed sequences over the set of preamble blocks, the one or more of the indexed sequences corresponding to the identified indices for the set of preamble blocks. The operations of 2130 may be performed according to the methods described herein. In some examples, aspects of the operations of 2130 may be performed by a preamble block manager as described with reference to FIGS. 12 through 15.

At 2135, the UE may transmit a data transmission during a TTI associated with the set of preamble blocks. The operations of 2135 may be performed according to the methods described herein. In some examples, aspects of the operations of 2135 may be performed by a data manager as described with reference to FIGS. 12 through 15.

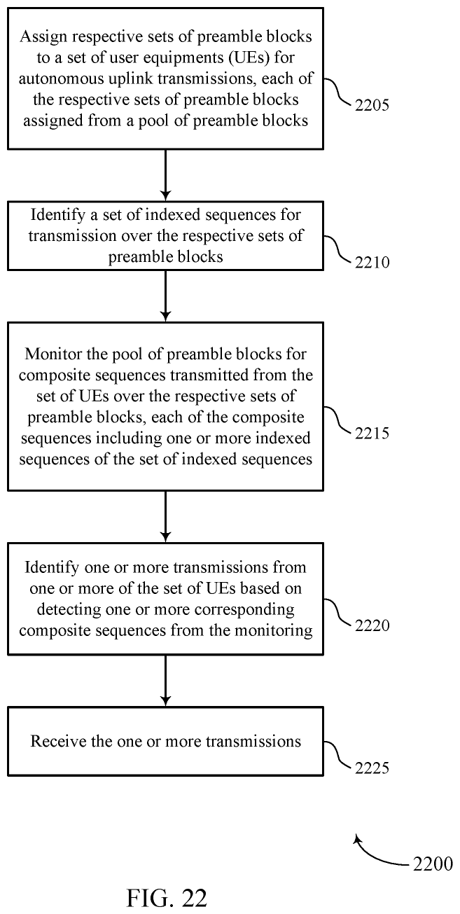

FIG. 22 shows a flowchart illustrating a method 2200 that supports block based preamble design for autonomous uplink transmissions in accordance with aspects of the present disclosure. The operations of method 2200 may be implemented by a base station 105 or its components as described herein. For example, the operations of method 2200 may be performed by a communications manager as described with reference to FIGS. 16 through 19. In some examples, a base station may execute a set of instructions to control the functional elements of the base station to perform the functions described below. Additionally, or alternatively, a base station may perform aspects of the functions described below using special-purpose hardware.

At 2205, the base station may assign respective sets of preamble blocks to a set of user equipments (UEs) for autonomous uplink transmissions, each of the respective sets of preamble blocks assigned from a pool of preamble blocks. The operations of 2205 may be performed according to the methods described herein. In some examples, aspects of the operations of 2205 may be performed by a preamble block manager as described with reference to FIGS. 16 through 19.

At 2210, the base station may identify a set of indexed sequences for transmission over the respective sets of preamble blocks. The operations of 2210 may be performed according to the methods described herein. In some examples, aspects of the operations of 2210 may be performed by a sequence manager as described with reference to FIGS. 16 through 19.

At 2215, the base station may monitor the pool of preamble blocks for composite sequences transmitted from the set of UEs over the respective sets of preamble blocks, each of the composite sequences including one or more indexed sequences of the set of indexed sequences. The operations of 2215 may be performed according to the methods described herein. In some examples, aspects of the operations of 2215 may be performed by a monitoring manager as described with reference to FIGS. 16 through 19.

At 2220, the base station may identify one or more transmissions from one or more of the set of UEs based on detecting one or more corresponding composite sequences from the monitoring. The operations of 2220 may be performed according to the methods described herein. In some examples, aspects of the operations of 2220 may be performed by a sequence manager as described with reference to FIGS. 16 through 19.

At 2225, the base station may receive the one or more transmissions. The operations of 2225 may be performed according to the methods described herein. In some examples, aspects of the operations of 2225 may be performed by a sequence manager as described with reference to FIGS. 16 through 19.

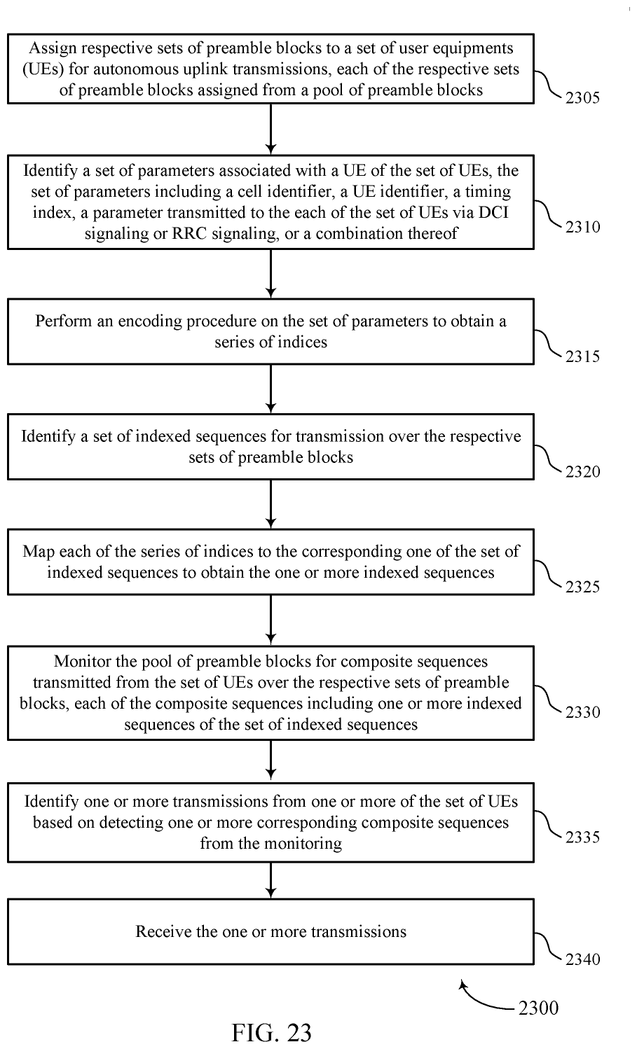

FIG. 23 shows a flowchart illustrating a method 2300 that supports block based preamble design for autonomous uplink transmissions in accordance with aspects of the present disclosure. The operations of method 2300 may be implemented by a base station 105 or its components as described herein. For example, the operations of method 2300 may be performed by a communications manager as described with reference to FIGS. 16 through 19. In some examples, a base station may execute a set of instructions to control the functional elements of the base station to perform the functions described below. Additionally, or alternatively, a base station may perform aspects of the functions described below using special-purpose hardware.

At 2305, the base station may assign respective sets of preamble blocks to a set of user equipments (UEs) for autonomous uplink transmissions, each of the respective sets of preamble blocks assigned from a pool of preamble blocks. The operations of 2305 may be performed according to the methods described herein. In some examples, aspects of the operations of 2305 may be performed by a preamble block manager as described with reference to FIGS. 16 through 19.

At 2310, the base station may identify a set of parameters associated with a UE of the set of UEs, the set of parameters including a cell identifier, a UE identifier, a timing index, a parameter transmitted to the each of the set of UEs via DCI signaling or RRC signaling, or a combination thereof. The operations of 2310 may be performed according to the methods described herein. In some examples, aspects of the operations of 2310 may be performed by a parameter manager as described with reference to FIGS. 16 through 19.

At 2315, the base station may perform an encoding procedure on the set of parameters to obtain a series of indices. The operations of 2315 may be performed according to the methods described herein. In some examples, aspects of the operations of 2315 may be performed by an encoding procedure operator as described with reference to FIGS. 16 through 19.

At 2320, the base station may identify a set of indexed sequences for transmission over the respective sets of preamble blocks. The operations of 2320 may be performed according to the methods described herein. In some examples, aspects of the operations of 2320 may be performed by a sequence manager as described with reference to FIGS. 16 through 19.

At 2325, the base station may map each of the series of indices to the corresponding one of the set of indexed sequences to obtain the one or more indexed sequences. The operations of 2325 may be performed according to the methods described herein. In some examples, aspects of the operations of 2325 may be performed by an index manager as described with reference to FIGS. 16 through 19.

At 2330, the base station may monitor the pool of preamble blocks for composite sequences transmitted from the set of UEs over the respective sets of preamble blocks, each of the composite sequences including one or more indexed sequences of the set of indexed sequences. The base station may monitor the pool of preamble blocks for the composite sequences based on the mapping. The operations of 2330 may be performed according to the methods described herein. In some examples, aspects of the operations of 2330 may be performed by a monitoring manager as described with reference to FIGS. 16 through 19.

At 2335, the base station may identify one or more transmissions from one or more of the set of UEs based on detecting one or more corresponding composite sequences from the monitoring. The operations of 2335 may be performed according to the methods described herein. In some examples, aspects of the operations of 2335 may be performed by a sequence manager as described with reference to FIGS. 16 through 19.

At 2340, the base station may receive the one or more transmissions. The operations of 2340 may be performed according to the methods described herein. In some examples, aspects of the operations of 2340 may be performed by a sequence manager as described with reference to FIGS. 16 through 19.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of wireless communication at a user equipment (UE), comprising:
identifying a set of preamble blocks for autonomous uplink transmissions, the set of preamble blocks being assigned by a base station from a pool of preamble blocks;
identifying an index for each preamble block of the set of preamble blocks, each of the identified indices corresponding to one of a set of indexed sequences;
transmitting one or more of the indexed sequences over the set of preamble blocks, the one or more of the indexed sequences corresponding to the identified indices for the set of preamble blocks; and
transmitting a data transmission during a transmission time interval (TTI) associated with the set of preamble blocks.

2. The method of claim 1, wherein identifying the index for each preamble block of the set of preamble blocks further comprises:
identifying a set of parameters, the set of parameters comprising a cell identifier, a UE identifier, a timing index, a parameter received via downlink control information (DCI) signaling or radio resource control (RRC) signaling, or a combination thereof.

3. The method of claim 2, wherein identifying the index for each preamble block of the set of preamble blocks comprises:
performing an encoding procedure on the set of parameters to obtain a series of indices; and
mapping each of the series of indices to the corresponding one of the set of indexed sequences to obtain the one or more of the indexed sequences.

4. The method of claim 3, wherein performing the encoding procedure comprises:
representing the set of parameters as a bit stream;
dividing the bit stream into a plurality of sub streams;
performing a stream encoding operation on the plurality of sub streams to obtain a set of encoded sub streams, a number of encoded sub streams in the set of encoded substreams corresponding to a number of preamble blocks in the set of preamble blocks; and
mapping each encoded substream of the set of encoded substreams to a respective one of the set of indexed sequences.

5. The method of claim 4, wherein performing the stream encoding operation comprises:
mapping each of the plurality of sub streams to one of a first plurality of numbers, the first plurality of numbers having a first dimension.

6. The method of claim 5, wherein the performing the stream encoding operation comprises:
encoding the mapped plurality of sub streams according to a generator matrix to obtain the set of encoded substreams, wherein a dimension of the generator matrix corresponds to the number of preamble blocks.

7. The method of claim 3, wherein performing the encoding procedure comprises:
representing the set of parameters as bit stream;
encoding the bit stream to obtain an encoded bit stream;
dividing the encoded bit stream into a plurality of encoded sub streams, a number of encoded sub streams in the plurality of encoded sub streams corresponding to a number of preamble blocks in the set of preamble blocks; and
mapping each encoded substream of the plurality of encoded substreams to a respective one of the set of indexed sequences.

8. The method of claim 7, wherein performing the encoding procedure comprises:
interleaving and scrambling the bit stream prior to the encoding.

9. The method of claim 7, wherein performing the encoding procedure comprises:
interleaving and scrambling the encoded bit stream prior to the dividing.

10. The method of claim 1, wherein each preamble block of the set of preamble blocks comprises a plurality of time-frequency resources.

11. The method of claim 1 wherein identifying the set of preamble blocks further comprises:
mapping the set of preamble blocks to a set of physical resources according to a mapping function.

12. The method of claim 11, wherein the mapping function comprises:
mapping the set of preamble blocks to consecutive time-frequency resources, interleaved time-frequency resources, or comb based interleaved time-frequency resources.

13. The method of claim 1, wherein each indexed sequence of the set of indexed sequences is a Zadoff-Chu sequence with a respective root and cyclic shift, a Gold sequence with a respective initial register status, a Galois sequence, an orthogonal basis sequence, or any combination thereof.

14. The method of claim 1, further comprising:
transmitting a demodulation reference signal (DMRS) after transmitting the one or more of the indexed sequences over the set of preamble blocks and prior to transmitting the data transmission.

15. The method of claim 14, further comprising:
identifying a set of parameters, the set of parameters comprising a cell identifier, a UE identifier, a parameter received via a downlink control information (DCI), a parameter received via a radio resource control (RRC) signal, or a combination thereof and transmitting the DMRS based at least in part on the set of parameters.

16. A method of wireless communication at a base station, comprising:
assigning respective sets of preamble blocks to a set of user equipments (UEs) for autonomous uplink transmissions, each of the respective sets of preamble blocks assigned from a pool of preamble blocks;
identifying a set of indexed sequences for transmission over the respective sets of preamble blocks;
monitoring the pool of preamble blocks for composite sequences transmitted from the set of UEs over the respective sets of preamble blocks, each of the composite sequences including one or more indexed sequences of the set of indexed sequences;
identifying one or more transmissions from one or more of the set of UEs based at least in part on detecting one or more corresponding composite sequences from the monitoring; and
receiving the one or more transmissions.

17. The method of claim 16, further comprising:
identifying a set of parameters associated with a UE of the set of UEs, the set of parameters comprising a cell identifier, a UE identifier, a timing index, a parameter transmitted to the each of the set of UEs via downlink control information (DCI) signaling or radio resource control (RRC) signaling, or a combination thereof.

18. The method of claim 17, wherein monitoring the pool of preamble blocks for the composite sequences further comprises:
performing an encoding procedure on the set of parameters to obtain a series of indices;
mapping each of the series of indices to the corresponding one of the set of indexed sequences to obtain the one or more indexed sequences; and
monitoring the pool of preamble blocks for the composite sequences based at least in part on the mapping.

19. The method of claim 18 wherein performing the encoding procedure comprises:
representing the set of parameters as a bit stream;
dividing the bit stream into a plurality of substreams;
performing a stream encoding operation on the plurality of substreams to obtain a set of encoded substreams, a number of encoded substreams in the set of encoded substreams corresponding to a number of preamble blocks in the respective set of preamble blocks;
mapping each encoded substream of the set of encoded substreams to a respective one of the set of indexed sequences; and
monitoring the pool of preamble blocks for the composite sequences based at least in part on the mapped set of encoded substreams.

20. The method of claim 19, wherein performing the stream encoding operation comprises:
mapping each of the plurality of sub streams to one of a first plurality of numbers, the first plurality of numbers having a first dimension.

21. The method of claim 20, wherein performing the stream encoding operation comprises:
encoding the mapped plurality of sub streams according to a generator matrix to obtain the set of encoded substreams, wherein a dimension of the generator matrix corresponds to the number of preamble blocks.

22. The method of claim 18, wherein performing the encoding procedure comprises:
representing the set of parameters as bit stream;
encoding the bit stream to obtain an encoded bit stream;
dividing the encoded bit stream into a plurality of encoded sub streams, a number of encoded sub streams in the plurality of encoded sub streams corresponding to a number of preamble blocks in the respective set of preamble blocks; and
mapping each encoded substream of the plurality of encoded substreams to a respective one of the set of indexed sequences.

23. The method of claim 22, wherein performing the encoding procedure comprises:
interleaving and scrambling the bit stream prior to the encoding.

24. The method of claim 23, wherein performing the encoding procedure comprises:
interleaving and scrambling the encoded bit stream prior to the dividing.

25. The method of claim 16, wherein each preamble block of the respective sets of preamble blocks comprises a plurality of time-frequency resources.

26. The method of claim 16, wherein assigning the respective sets of preamble blocks further comprises:
mapping the preamble blocks to consecutive time-frequency resources, interleaved time-frequency resources, or comb based interleaved time-frequency resources.

27. The method of claim 16, wherein each indexed sequences of the set of indexed sequences is a Zadoff-Chu sequence with a respective root and cyclic shift, a gold sequence with a respective initial register status, a Galois sequence, an orthogonal basis sequence, or any combination thereof

28. The method of claim 16, wherein receiving the one or more transmissions comprises:
receiving a composite sequence of the one or more corresponding composite sequences from a UE of the set of UEs;
receiving a demodulation reference signal (DMRS) after receiving the composite sequence; and
receiving a data transmission after receiving the DMRS.

29. An apparatus for wireless communication at a user equipment (UE), comprising:
a processor, memory coupled with the processor; and
instructions stored in the memory and executable by the processor to cause the apparatus to:
identify a set of preamble blocks for autonomous uplink transmissions, the set of preamble blocks being assigned by a base station from a pool of preamble blocks;
identify an index for each preamble block of the set of preamble blocks, each of the identified indices corresponding to one of a set of indexed sequences;
transmit one or more of the indexed sequences over the set of preamble blocks, the one or more of the indexed sequences corresponding to the identified indices for the set of preamble blocks; and
transmit a data transmission during a transmission time interval (TTI) associated with the set of preamble blocks.

30. An apparatus for wireless communication at a base station, comprising:
a processor, memory coupled with the processor; and
instructions stored in the memory and executable by the processor to cause the apparatus to:
assign respective sets of preamble blocks to a set of user equipments (UEs) for autonomous uplink transmissions, each of the respective sets of preamble blocks assigned from a pool of preamble blocks;
identify a set of indexed sequences for transmission over the respective sets of preamble blocks;
monitor the pool of preamble blocks for composite sequences transmitted from the set of UEs over the respective sets of preamble blocks, each of the composite sequences including one or more indexed sequences of the set of indexed sequences;
identify one or more transmissions from one or more of the set of UEs based at least in part on detecting one or more corresponding composite sequences from the monitoring; and
receive the one or more transmissions.
